(19) United States
(12) Patent Application Publication
(10) Pub. No.: US 2026/0125214 A1
(43) Pub. Date: May 7, 2026

(54) VERTICAL CAROUSEL

(71) Applicant: Ocado Innovation Limited, Hatfield (GB)

(72) Inventors: Leslie WYNN, Hatfield (GB); Oliver Frederick KIRKBY, Hatfield (GB); Keith Derek HABBEN, Hatfield (GB)

(21) Appl. No.: 19/381,409

(22) Filed: Nov. 6, 2025

Related U.S. Application Data
(63) Continuation of application No. PCT/EP2024/062998, filed on May 10, 2024.

(30) Foreign Application Priority Data
May 10, 2023 (GB) 2306911.5

(51) Int. Cl. B65G 1/04; B65G 1/06; B65G 1/137

(52) U.S. Cl. CPC B65G 1/0464; B65G 1/065; B65G 1/1378

(57) ABSTRACT

A storage and retrieval system is provided. The system includes:
a) a track system, the track system comprising a plurality of grid members or tracks arranged in a grid pattern comprising a plurality of grid cells or spaces;
b) at least one vertical carousel comprising a drive mechanism for circulating a plurality of containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space.

### TECHNICAL FIELD

The present invention relates to the field of storage and retrieval systems comprising robotic load handling devices operative on tracks located on a grid framework structure for handling storage containers stored in the grid framework structure.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

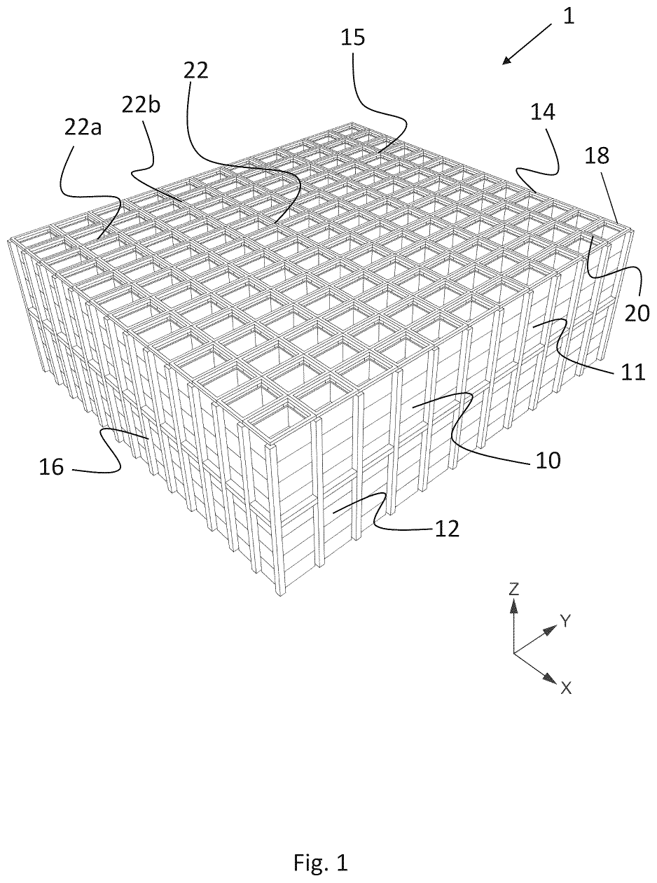

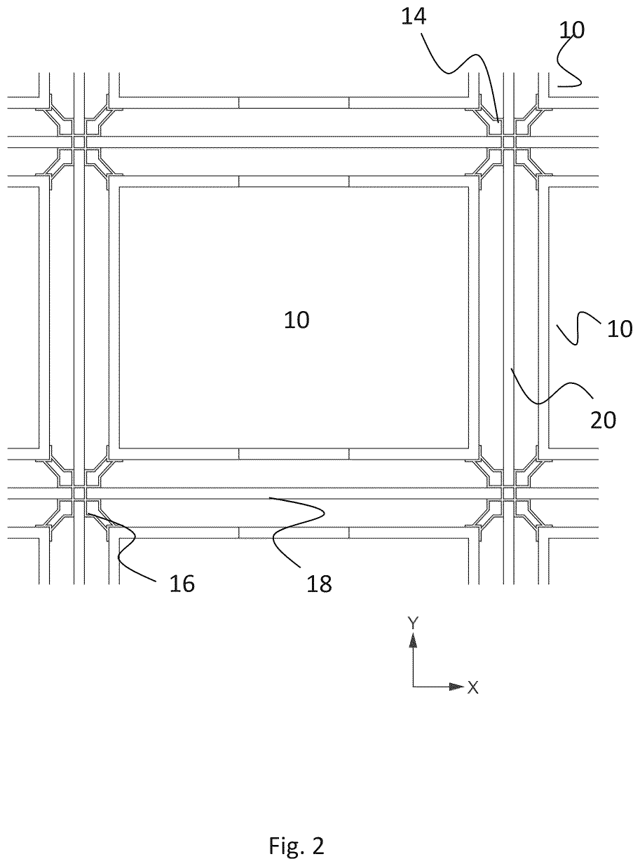

As shown in FIGS. 1 and 2, the storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 11. Each grid in the grid framework structure has at least one storage column 11 for storage of a stack of containers. FIG. 1 is a schematic perspective view of the grid framework structure 14, and FIG. 2 is a top-down view showing a single stack 12 of containers 10 arranged within the framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

The grid framework structure 14 comprises a plurality of upright members or upright columns 16 that support horizontal members 18, 20. A first set of parallel horizontal grid members 18 is arranged perpendicularly to a second set of parallel horizontal grid members 20 to form a grid structure lying in a substantially horizontal plane and supported by the upright members 16. The members 16, 18, 20 are typically manufactured from metal and typically welded or bolted together or a combination of both. The storage containers 10 are stacked between the upright members 16 of the grid framework structure 14, so that the grid framework structure 14 guards against horizontal movement of the stacks 12 of the storage containers 10, and guides vertical movement of the storage containers 10.

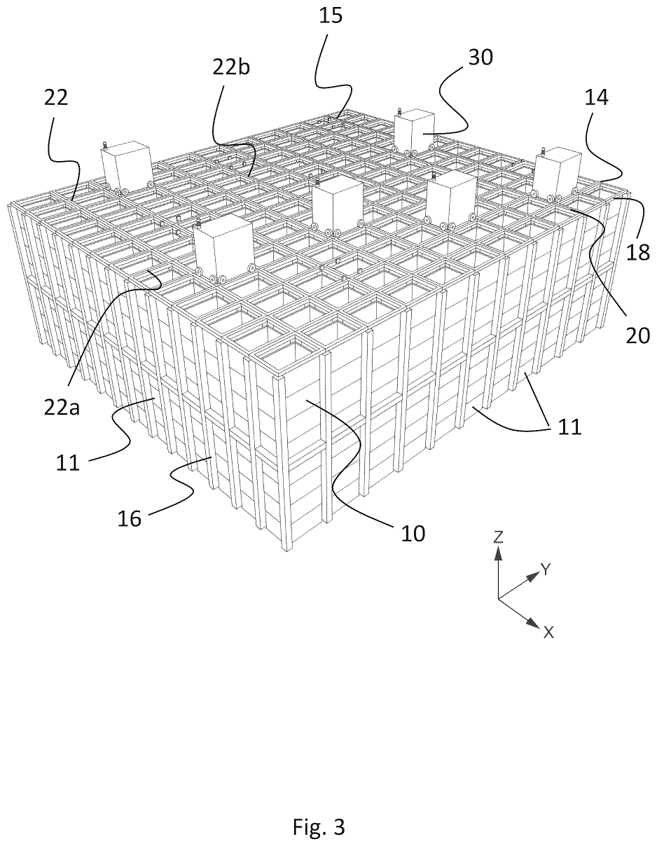

The top level of the grid framework structure 14 includes a track system 15 comprising a plurality of grid members, rails or tracks 22 arranged in a grid pattern across the top of the stacks 12. Referring additionally to FIG. 3, the rails 22 support a plurality of load handling devices or robotic load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. The track system 15 can be integrated into the grid structure in the sense that the first and second sets of tracks are respectively integrated into the first and second set of grid members. Alternatively, the track system 15 can be separate to the grid structure in the sense that the first and second sets of tracks are respectively mounted to the first and second sets of grid members. The system described with reference to FIGS. 1 to 3 is generally described as a “cubic” storage system and has many advantages and is suitable for a wide range of storage and retrieval operations. In particular, it allows very dense storage of product, and it provides a very economical way of storing a huge range of different items in the containers 10, while allowing reasonably economical access to all of the containers when required for picking.

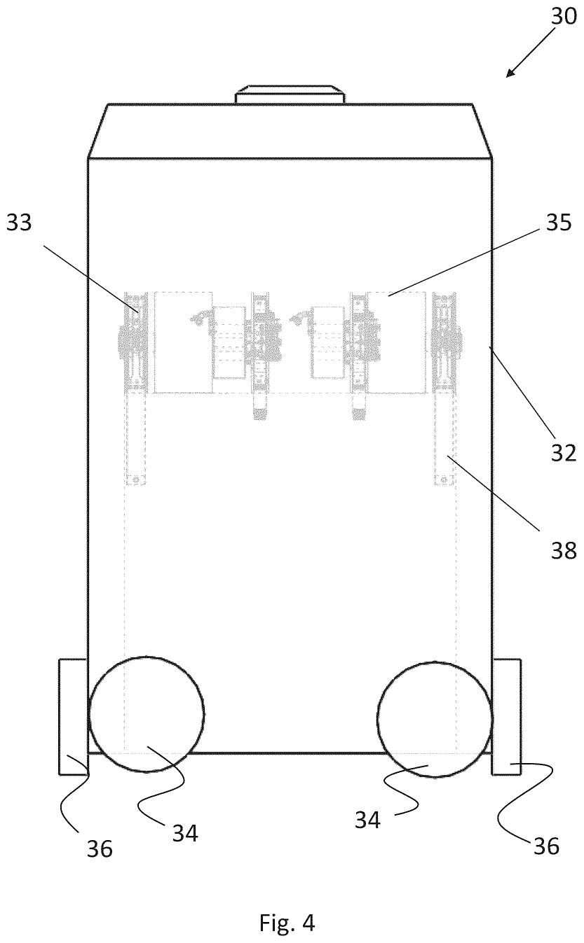

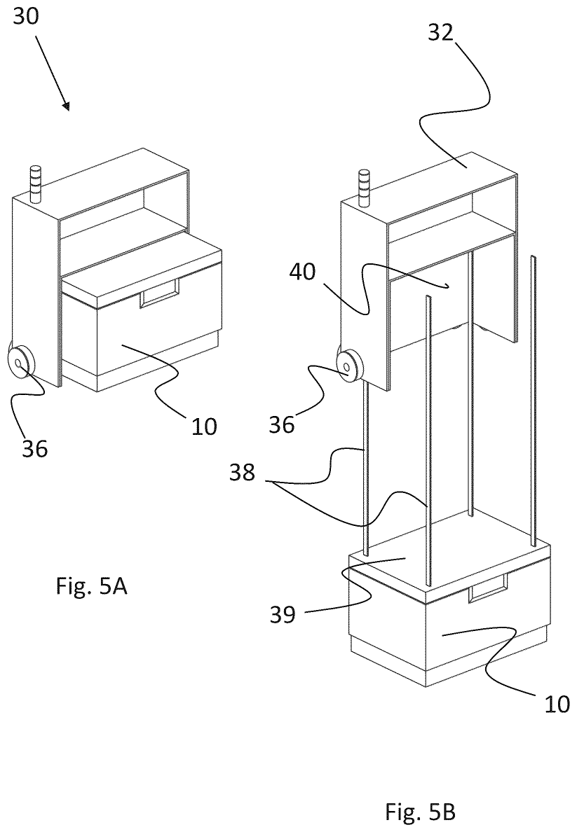

Each load handling device 30 comprises a vehicle body 32 which is arranged to travel in the X and Y directions on the tracks or rails 22 of the grid frame structure 14, above the stacks 12 (see FIG. 4). FIGS. 4 and 5A-5B shows a load handling device 30 described in PCT Patent Publication No. WO2015/019055 (Ocado Innovation Limited) and International patent application WO 2015/140216 (Ocado Innovation Limited) comprising a vehicle body 32 equipped with a lifting mechanism 33 comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

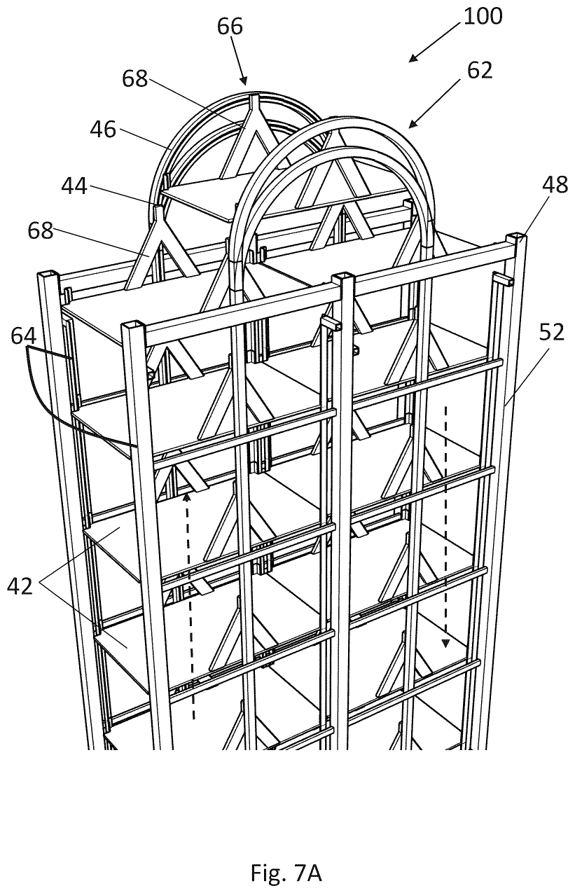

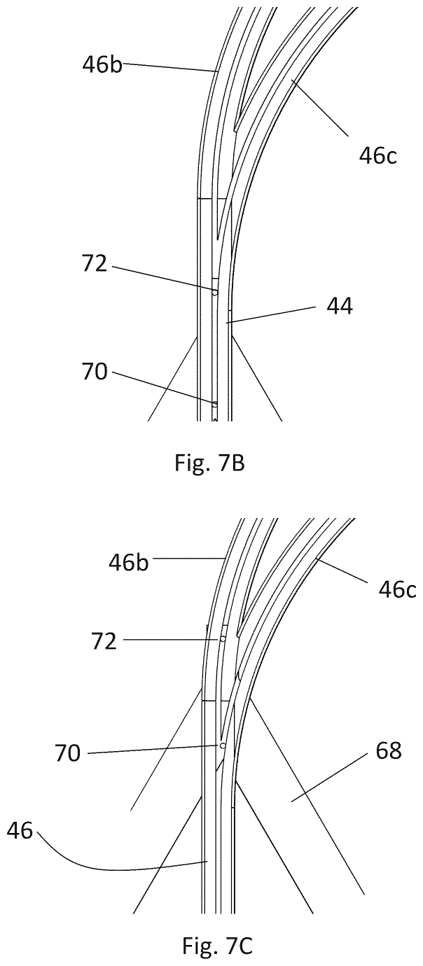

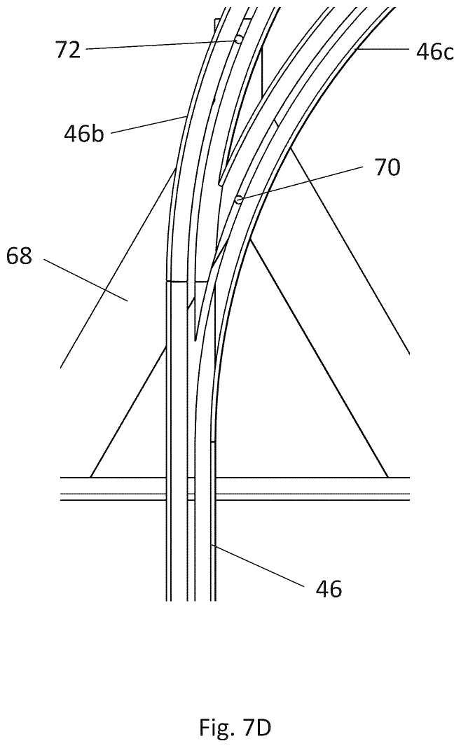

To grab a container 10, the grabber device 39 comprises four locating pins or guide pins nearby or at each corner of the grabber device 39 which mate with corresponding cut outs or holes formed at four corners of the storage container 10 and four gripper elements arranged at the bottom side of the grabber device 39 to engage with the rim of the storage container 10. The locating pins help to properly align the gripper elements with corresponding holes in the rim of the container. Each of the gripper elements comprises a pair of wings or legs that are collapsible to be receivable in corresponding holes in the rim of the storage container and an open enlarged configuration having a size greater than the holes in the rim of the storage container 10 in at least one dimension so as to lock onto the storage container 10. The wings are driven into the open configuration by a drive gear (not shown). More specifically, the head of at least one of the wings comprises a plurality of teeth that mesh with the drive gear such that when the gripper elements are actuated, rotation of the drive gear causes the pair of wings to rotate from a collapsed configuration to an open enlarged configuration (FIG. 7B).

The vehicle body 32 comprises an upper part and a lower part (see FIGS. 5A and 5B). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that is are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism comprising a winch, as shown in FIGS. 5A and 5B. When in the recess, the container is lifted clear of the rails beneath, so that the load handling device can move laterally to a different location. Whilst the container receiving space 40 is shown in FIG. 4 arranged within the vehicle body 32, the container receiving space can be located below a cantilever as described in WO2019/238702 (Autostore Technology AS).

A typical storage and retrieval system 1 is shown in FIG. 3, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

Upon receipt of a customer order, a robotic load handling device operative to move on the tracks is instructed to pick up a storage bin containing the item of the order from a stack in the grid framework structure and transport the storage bin to a pick station whereupon the item can be retrieved from the storage bin. Typically, the load handling device transports the storage bin or container to a bin lift device that is integrated into the grid framework structure. A mechanism of the bin lift device lowers the storage bin or container to a pick station. Alternatively, the storage bin is lowered by the lifting mechanism of the robotic load handling device to the pick station.

A grid framework structure normally has at least one grid cell or storage column which is used not for storing storage containers, but which comprises a location where the load handling devices can drop off and/or pick up storage containers so that they can be transported to a second location (not shown in the prior art figures) where the storage containers can be accessed from outside of the grid framework structure or transferred out of or into the grid framework structure. Within the art, such a location is normally referred to as a “port” and the grid cell or storage column in which the port is located may be referred to as a “delivery column”. The storage columns typically comprise two delivery columns. A first delivery column may, for example, comprise a dedicated drop-off port where the robotic load handling vehicles or load handling vehicles can drop off storage containers to be transported through the delivery column and further to the pick station, and a second delivery column may comprise a dedicated pick-up port where the robotic load handling vehicles can pick up storage containers that have been transported through the second delivery column from the pick station, i.e. storage containers are fed into the pick station via the first delivery column and exit the access station via the second delivery column.

At the pick station, the item is retrieved from the storage bin. Picking can be done manually by hand or by a robot. After retrieval from the storage bin, the storage bin is transported to a second bin lift device whereupon it is lifted to grid level to be retrieved by a load handling device and transported back into its location within the grid framework structure. Alternatively, the storage bin can be picked up by the lifting mechanism of the robotic load handling device through the pick-up port. A control system and a communication system keeps track of the location of the storage bins and their contents within the grid framework structure.

As individual storage containers are stacked in vertical layers in storage columns, their locations in the grid framework structure or “hive” may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid, i.e. the layer immediately below the rail system, Z=2 is the second layer below the rail system and so on to the lowermost, bottom layer of the grid.

A problem with standard grid framework structures is that load handling devices must dig to reach a container at the bottom of a stack. For this, several load handling devices must work together to move each individual container from the stack, so that the desired container at the bottom of the stack can be accessed. Once the desired container is picked up from the stack by a load handling device, the previously removed containers from the stack may be put back into the stack from which they originated. Thus, the digging process takes time to retrieve storage containers and uses several load handling devices, resulting in increased costs.

Further, as electronic commerce (e-commerce) continues to grow and overtake conventional brick and mortar retail practices, many businesses are facing challenges of maintaining or gaining relevance in an online marketplace and being able to compete with prominent players in the space. A typical supply chain involves the storage and retrieval of a large number of different products. For example, e-commerce and retail platforms that sell multiple product lines require systems that are able to store hundreds of thousands of different product lines having different temperature requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. For example, where an order of one or more items involves the delivery of food and grocery goods that are of a perishable nature, storage of goods must adhere to strict temperature and environmental requirements, e.g., chilled or frozen temperature. For example, some types of food require a cool temperature environment (typically temperatures between 1° C.-8° C.), some types of food require an even colder temperature environment (typically temperatures lower than −15° C.), and other types of food require a higher temperature environment (typically temperatures above 10° C.).

Conventional multi-temperature storage and retrieval systems typically require a walk-in cooler or freezer to be pre-constructed or additional components to be installed around the storage and retrieval system discussed above, which substantially expands the footprint of the storage and retrieval system and increases the cost and complexity of installing and operating the storage and retrieval system across multiple environmentally controlled zones. As a result, there has been a need for a freestanding, high density, automated storage and retrieval system with multiple integrated, environmentally controlled zones that removes the need of separate walk-in, environmentally controlled zones that operate independently of the storage and retrieval system.

In attempt to adapt an existing automated storage and retrieval system to provide storage for sensitive item, e.g. chilled or frozen items, WO2015124610 (Autostore Tech AS) relates to a storage system for receiving and storing processed refrigerated and frozen food products where there is provided thermal insulation between at least a section of the grid structure and the remotely operated vehicle. The system comprises insulating covers arranged in the top level of the grid structure. The insulating covers provide a thermal barrier towards the remotely operated vehicle as well as contributing to maintaining the desired temperature in the bins in the grid structure. The insulating covers are arranged to be movable by means of the remotely operated vehicle. The vehicle can move one insulating cover to another cell in the grid, or hold it temporarily while a bin is removed from the stack.

WO2021198170 (Autostore Tech AS) relates to an automated storage and retrieval system for storing specialized goods in storage containers in an isolating housing, having walls and a roof. Openable and closable hatches are arranged in the roof. A storage tower is arranged inside the isolating housing such that the storage tower being accessible to a container handling vehicle though the hatch. The storage tower has a number of vertically stacked, horizontally movable container supports in the form of shelves upon which may rest a plurality of storage containers and one or more openings corresponding in size to a storage container such that storage containers may pass therethrough. The container supports may align their openings to form a tower port beneath a hatch, through which the container handling vehicle may lower its lifting device though the hatch, down the tower port, and access the target container.

In both teachings, there is a requirement that the thermal insulation covering of the grid cell has to be removed or moved aside so that a container handling vehicle operating on the grid structure is able to gain access to one or more storage containers in storage. Not only does this introduce an additional step when retrieving storage containers from the storage system but there is no guarantee that the thermal insulation covers of the grid cells will provide adequate insulation to prevent the ingress of warmer air into the grid structure from the ambient region above the grid structure. To prevent the ingress of air from the ambient region into the grid structure, it is essential that the grid cells are adequately sealed from the ambient region above the thermal insulation covers. However, the use of thermal insulation covers for each of the grid cells introduces an additional complexity of the need to be easily removal in order to gain access to one or more storage container in storage in the grid structure.

To mitigate this problem, a fleet of robotic load handling devices are disposed in a chilled, or freezer environment. In these facilities, the robotic load handling devices reside and operate in the chilled or freezer on a full-time basis. Whilst having a fleet of load handling devices operating in the chilled or freezer environment on a full-time basis automates the storage and retrieval of storage containers from the storage system, there will be occasions where one or more load handling devices would have to be taken out service. This could be as a result of a breakdown or malfunction of the load handling device or simply the need to service the load handling device. In both cases, access to the load handling device would be required by maintenance personal. However, in the case where the load handling device resides in the freezer temperature area, which can be low as −30° C., this introduces another problem of the health and safety of the maintenance personal working at such low temperatures.

A storage and retrieval system is thus required which overcomes the above problems.

### SUMMARY OF THE INVENTION

A storage and retrieval system is provided. An example system comprises:
a) a track system, the track system comprising a plurality of grid members arranged in a grid pattern comprising a plurality of grid cells or spaces;
b) at least one vertical carousel comprising a drive mechanism for circulating a plurality of containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space.
The track system may comprise a first set of parallel rails or grid members extending in a first direction (x), and a second set of parallel rails or grid members extending in a second direction (y) perpendicular to the first direction. Thus, the arrangement of the grid members forms a grid pattern comprising a plurality of grid cells or spaces. The terms ‘grid cell’ and ‘grid space’ are used interchangeably throughout this application. Each grid cell or grid space is sized to fit a storage container and allow a storage container to be moved in and out of the grid cell. The track system may be suitable for guiding movement of a load handling device in a first direction (x) or a second direction (y). Alternatively, or addition, the track system may be suitable for interaction with a gantry system, as described later. The vertical carousel may be located beneath the track system. This arrangement allows a storage container to be lifted through a grid space from the vertical carousel, or lowered through a grid cell into the vertical carousel. Specifically, the storage container may be lifted from and/or lowered to an uppermost position of the vertical carousel, the uppermost position being adjacent to the track system. The term ‘storage container’ and ‘container’ are used interchangeably throughout this application.

The vertical carousel allows the circulation of a plurality of containers around a vertical endless loop such that any storage container in the vertical carousel is accessible from the track system when it reaches the uppermost position of the vertical carousel and is aligned with a grid cell or grid space. As the loop or vertical carousel circulates, each storage container is paused at the uppermost position of the vertical carousel and therefore each storage container is repeatedly accessible from the track system. This arrangement is particularly advantageous because there is no requirement for, for example, load handling devices operable on the track system to dig through a stack of storage containers to reach a storage container at or near the bottom of a stack. Using a vertical carousel to store storage containers results in a more efficient storage and retrieval system.

Optionally, the at least one vertical carousel has a width that occupies only two grid cells. For the purpose of the present invention, the phrase “having a width that occupies only two grid cells” can be construed to mean that the vertical carousel has a footprint that extends across only two or a pair of grid cells. For a plurality of grid members arranged in a grid pattern, the footprint of the vertical carousel can extend two grid cells in the first direction (x-direction) or in the second (y-direction). The advantage of a vertical carousel having a footprint that extends only two grid cells is the ability to have a close packed arrangement of a plurality of storage containers. This is particularly advantageous as the vertical carousel can be used to store a plurality of storage containers in a densely packed arrangement. This can be used in conjunction with one or more stacks of storage containers in a separate storage system. To store a plurality of storage containers in a closed packed arrangement, optionally, a height of the at least one vertical carousel is greater than its width such that a plurality of the series of carriers are arranged vertically. Vertically arranging a plurality of carriers enables a plurality of storage containers to be stored in a vertical arrangement. Moreover, having the at least one vertical carousel having a width that extends only two grid cells complements a load handling device having a footprint that occupies only a single grid cell. This is because the load handling device is able to position itself above a grid cell when the least one vertical carousel moves a storage container to the uppermost position below the grid cell without the need to occupy a neighbouring grid cell.

The storage and retrieval system may comprise a grid framework structure comprising a track system on which a load handling device and/or a gantry system operates, and one or more vertical carousels. Optionally, the storage and retrieval system may further comprise a supporting frame structure comprising a plurality of storage columns, each of the plurality of storage columns being configured to store a stack of storage containers, said track system is mounted to the supporting framework structure such that each grid storage column of the plurality of storage columns is arranged below a respective grid cell of the plurality of grid cells to define a grid framework structure. Additionally the storage and retrieval system may comprise one or more stacks of storage containers and may additionally comprise port cells to enable movement of storage containers out of or into the grid framework structure, for example, to and from a pick station. As a result of the load handling devices not being required to dig to reach a desired container in the system, the grid framework structure can be made smaller than conventional grid framework structures. For example, the track system may not need to extend as far in the x and y directions compared to conventional track systems as it does not need to accommodate multiple load handling devices moving storage containers around the grid framework structure to access a desired storage container near the bottom of a stack. Further, because storage containers are stored in a vertical carousel, rather than in stacks, it is possible to store more storage containers in a smaller (xy) area as the vertical carousel can be arranged to safely store a greater height of storage containers compared to a stack of storage containers where increasing the height of the stack may result in the stack becoming more unsteady. For example, the system may comprise a vertical carousel which extends between 10 to 20, or 20 to 25, or 25 to 30 storage containers high.

The vertical carousel comprises a drive mechanism which circulates the containers around a vertical endless loop. The drive mechanism may be a motor. The containers may be circulated in a clockwise or an anticlockwise direction. The vertical carousel circulates the containers around an endless vertical loop such that is no specific starting position or end position for each of the containers. Each of the containers circulates from a lowermost position to an uppermost position adjacent to the track. Because the containers circulate around an endless vertical loop, the containers also circulate from an uppermost position to a lowermost position. The lowermost position being a position where the containers are accessible at ground level. The uppermost position is equivalent to a Z=1 position as used in the art, i.e., the uppermost position is the uppermost layer of the grid, i.e. the layer immediately below the rail system. If the containers are not lifted through a grid cell from the uppermost position, the containers continue to move to the lowermost position and then to the uppermost position, until the container is removed from the vertical carousel from the uppermost position by lifting the container through a grid cell in the track system.

As the vertical carousel circulates the containers around the vertical endless loop, the vertical conveyor indexes the containers in sequential steps. This is controlled by the control system which is operatively coupled to the drive mechanism. Movement of the drive mechanism and thus the plurality of carriers may be controlled or coordinated by the control system. Indexing the containers in sequential steps gives time for a container to be lifted from and/or lowered into the vertical carousel through the grid cell or grid space. The drive mechanism for example may comprise indexing means to index the movement of a plurality of carriers sequentially such that the carriers travel around a continuous vertical loop and such that an uppermost indexing position is aligned with a grid cell in the track system. The containers on the carriers may be indexed in predetermined intervals, rather than pausing when each container on a vertical carousel reaches the uppermost position. This is particularly advantageous to reduce time for picking a specific container from the vertical carousel. For example, if a specific container located at the lowermost location on the vertical carousel is desired, the vertical carousel may rotate the desired container from the lowermost position to the uppermost position without pausing when each container on the vertical carousel reaches the uppermost position. Alternatively, the vertical carousel may index each carrier around the endless loop such that each carrier or each container on a carrier is indexed and paused when it reaches the uppermost position of the vertical carousel. Thus, in this configuration, the vertical carousel continues to rotate and pause as each container reaches the uppermost position regardless of the position of the desired storage container. This configuration is a simpler arrangement to automate and control.

The storage containers may be loaded into or unloaded from the vertical carousel from the track system by a load handling device or a gantry system, or another means suitable for lifting or retrieving and lowering or depositing storage containers into and out of the vertical conveyor. Using a load handling device or gantry system allows empty storage containers to be removed from the vertical carousel and full storage containers may be loaded into the vertical carousel in a simple and efficient manner. Alternatively, the lowermost position may be arranged to allow retrieval of storage containers at ground level. In this configuration, storage containers may be lowered or deposited through a grid cell into the uppermost position of the vertical carousel by a load handling device or a gantry system, the vertical carousel may rotate such that the storage container is positioned at the lowermost position and the storage container may be retrieved at ground level from the lowermost position. The storage container may be retrieved from the lowermost position by any suitable means, such as a robotic arm, sliding mechanism, conveyor mechanism, or by a person. It is therefore particularly preferable to have the vertical conveyor at or near the periphery of the storage and retrieval system to allow additional apparatus or people to be easily positioned near the vertical carousel.

Preferably, the vertical carousel further comprises a series of carriers for accommodating and conveying the plurality of containers. Each carrier may accommodate and support one or more storage containers so that they can be circulated in a loop. For example, each carrier may accommodate a row of storage containers, and so in this arrangement the vertical carousel extends across a row of grid cells in the x or y direction. The carriers may be sized to accommodate multiple sizes of containers, for example, the carriers may accommodate containers having half the height of a standard container (a standard container having, for example, exterior dimensions of approximately 45 cm width by 65 cm length by 36 cm high). The carriers may be subdivided such that containers accommodated in a row on a carrier are separated on each carrier. The carriers may comprise shelving, a fork, a tray or a platform. It may be possible to slide, place or remove the storage containers from the shelving, fork, tray or platform. Further, the shelving, fork, tray or platform is arranged such that a storage container can be loaded onto or removed from either side of the vertical carousel. The carriers may be connected to a drive member which circulates in a loop circulating the carriers and the storage containers supported by the carriers around the loop. The drive member may be a chain or a belt. Specifically, the plurality of carriers may be moveably coupled to the belt such that each of the plurality of platforms remains substantially horizontal as the direction of the drive member changes when driven around the vertical loop, e.g., from an upward direction to a downward direction. In this configuration of the coupling between the plurality of carriers and the belt, the plurality of carriers are configured to rotate about a horizontal axis extending through the coupling with the belt so as to keep the orientation of the plurality of carriers substantially horizontal as they travel around the uppermost and lowermost portion of the vertical conveyor. The vertical carousel may also comprise a guide member for guiding the plurality of carriers around the vertical loop. The drive mechanism may move the plurality of carriers around the guide member. To provide support to the plurality of carriers for carrying one or more storage containers, the guide member can be configured so that preferably, each of the plurality of platforms is supported by at least three points of contact by the guide member, more preferably, supported on all four corners of the platform. The guide member may comprise orientation means so as to maintain the carriers in a substantially horizontal orientation as they transfer from the uppermost position to the lowermost position and vice versa when travelling around the vertical loop.

Preferably, the uppermost position of the vertical carousel is arranged to receive storage containers for circulating around the vertical carousel. Thus, in this arrangement, storage containers may be deposited in the uppermost position of the vertical carousel via the grid spaces. The storage container may be lowered into the vertical carousel by a gantry system or by a load handling device, specifically a grabber device of a load handling device.

Preferably, the plurality of containers on the vertical carousel may be spaced apart such that there is a gap above and below each container to allow access to each container, preferably by a person. This arrangement also allows items which protrude from a storage container to not influence the position of the storage container above. By having a space or gap above and below each container, it is possible to move any protruding items from the storage container easily and without moving another storage container.

The system may comprise a plurality of vertical carousels, each vertical carousel being configured to operate independently. Moving and operating each vertical carousel individually can increase the speed of retrieval of multiple storage containers and/or multiple items from multiple storage containers. Preferably, the plurality of vertical carousels are disposed laterally to each other to form a row of vertical carousels (i.e., side by side to each other). By laterally disposing the plurality of vertical carousels laterally relative to each other enables a plurality of storage containers to be arranged in multiple rows extending across the plurality of the vertical carousels. This means that all the vertical carousels are located together within a specific region of the storage and retrieval system.

Each vertical carousel may be enclosed in an insulated environment. Specifically, if each vertical carousel is enclosed in an insulated environment, it is particularly advantageous to keep all of the vertical carousels adjacent to each other such that they are all in the same insulated environment. It is also advantageous to have the insulated area embedded in a grid framework structure, as this saves space. The temperature of the insulated environment may be between −10° C. and −30° C. This temperature range is particularly important for the storage of frozen goods. Preferably, the temperature of the insulated environment may be between −18 and −23° C. Alternatively, the temperature of the insulated environment is between 0° C. and 5° C. This temperature range is particularly suitable for the storage of chilled goods.

Preferably, each of the grid cells is closable by a shutter to provide and restrict access to the storage containers at an uppermost position on the vertical carousel. The shutters segregate the track system from the vertical carousel. This is particularly useful when the vertical carousel is located in an insulated environment and the insulated environment is cooled. When the insulated environment is cooled, the shutters minimise the ingress of warm air into the insulated environment and/or the displacement of cool air in the insulated environment with warmer air above the track system, thereby minimising energy costs. Preferably, each shutter is configured to slidably open and close. Slidably opening and closing the shutters minimises the amount of space required for the shutters to operate. Alternatively, each shutter may be attached to a grid cell by a hinge which acts as a pivot such that each shutter rotates about the pivot and moves through the grid cell, thereby opening and closing the shutter. Alternatively, each shutter may be a bi-fold, tri-fold, multi-fold or concertina shutter.

Preferably, the system further comprises a gantry system, wherein the gantry system is operable on the track system, the gantry system comprising a lifting mechanism for lifting and/or lowering a storage container through a grid cell or grid space. A gantry system is mechanically easier to operate than, for example, a load handling device. The gantry system also offers a cost saving alternative to, for example a load handling device and also allows for multi-axis operation. The gantry system may comprise a gantry crane or frame or overhead bridge which straddles the track system. The overhead bridge may be stationary and the lifting mechanism may be traversably mounted to the overhead bridge such that the lifting mechanism can lift and lower storage containers and move the storage containers along a row of grid cells so that the storage containers can be moved from one location in the row of grid cells to another location in the row of grid cells. Alternatively, or in addition, the gantry system may be moveable on the track system, in particular, the overhead bridge may be moveable across the track system in either an x or a y direction such that storage containers can be picked and/or deposited over a wider area of the track system. The gantry system may comprise a plurality of overhead bridges. Each of the plurality of frames or overhead bridges may allow storage containers to be picked and/or deposited in a specific area of the track system. The plurality of frames or overhead bridges together ensure that all of the track system is accessible for picking and/or depositing storage containers. For the purposes of describing movement of the gantry system, the gantry frame, crane or overhead bridge may move in a longitudinal direction and the direction of the motion of the robot along the gantry may be termed the lateral direction. Thus, the gantry frame may move in a perpendicular direction to the movement of the lifting mechanism. The lifting mechanism and the frame may move simultaneously for time efficiency. The lifting mechanism may comprise a hoist, a crane mechanism, a gantry robot or a robotic arm. A gantry robot or robotic arm may move in linear paths creating a three-dimensional (3D) cubic envelope of space within which it can retrieve/lift and deposit storage containers through grid cells in the track system to or from the vertical carousel. Further, the lifting mechanism may be traversably mounted on the moveable gantry frame, crane or overhead bridge.

The gantry system may be controllable by the control system, such that the gantry system (in particular the overhead bridge and/or the lifting mechanism) moves at the same time as the vertical carousel indexes the plurality of containers around the endless vertical loop in sequential steps. This advantageously saves time in retrieving desired storage containers from the vertical carousel.

Optionally, the storage and retrieval system further comprises one or more access positions between the uppermost position and the lowermost position of the vertical endless loop for accessing the content of one or more storage containers from the side of the at least one vertical carousel. Being able to access one or more of the storage containers from at least one side of the at least one of the vertical carousels allows the contents of the one or more storage containers to be accessed by an operator. Optionally, the storage and retrieval system further comprises at least one transfer system disposed laterally to the at least one vertical carousel, said at least one transfer system comprising at least one transfer conveyance system disposed laterally to the at least one vertical carousel, said at least one transfer conveyance system being configured to transport a storage container across the at least one vertical carousel. Optionally, said at least one transfer system comprising a transfer mechanism configured to transfer a storage container between a stowed position at the access position of the vertical carousel and a deployed position outwardly relative to the at least one vertical carousel such that the contents of the storage container can be accessed therein. To assist with the accessibility of the one or more storage containers from the at least side of the vertical carousel, optionally, the one or more storage containers are tiltable when in the deployed position.

In addition to or alternatively to retrieving a storage container vertically through a grid cell of the track system when the storage container is at the uppermost position, one or more storage containers can be retrieved laterally from the side of the at least one vertical carousel (e.g., in a substantially horizontal direction). The control system can be configured to index the plurality of the storage containers around the endless vertical loop such that each of the sequential steps corresponds to at least one of the plurality of storage containers being adjacent to the at least one transfer system. The transfer mechanism can be configured to retrieve the storage container by withdrawing the storage container from its carrier. For example, the transfer mechanism can comprise an arm that is configured to grasp the storage container and pull the storage container from its carrier supporting the storage container. Alternatively, the carrier supporting the storage container can comprise a conveyor unit, e.g., a belt driven device or roller, that is configured to push the storage container onto the transfer conveyance system. The transfer conveyance system can then be configured to transfer the storage container across the at least one vertical carousel. For example, the transfer conveyance system can transport the retrieved storage container to a picking station where the contents of the storage container can be picked to fulfil a customer order. The tilting of the one or more storage containers in the deployed position allows the operator to easily view the contents of the storage containers retrieved from the side of the at least one side of the vertical carousel. Optionally, the transfer mechanism comprises at least one grabber device moveable in a direction substantially perpendicular to an axis of rotation of the vertical endless loop to engage with a storage container at the access position. Optionally, the transfer mechanism comprises at least one shuttle having a support deck for supporting a storage container, said shuttle being moveable along one or more tracks across the at least one carousel. Optionally, said shuttle is moveable in a horizontal plane or in a longitudinal direction along the one or more tracks. The transfer conveyance system can be construed to comprise the one or more tracks adjacent the at least one vertical carousel for allowing the shuttle to move across the at least one vertical carousel.

Optionally, the at least one transfer system comprises a first transfer system and a second transfer system, said first transfer system being configured to transfer at least one storage container from the at least one vertical carousel to the deployed position and said second transfer system being configured to transfer at least one storage container to the stowed position in the at least one vertical carousel. Each of the first and second transfer systems respectively comprise a respective transfer mechanism for moving a storage container between the stowed position and the deployed position and a transfer conveyance system for transporting one or more storage containers across the at least one vertical carousel. To separately retrieve a storage container from the at least one vertical carousel and deposit a storage container into the at least vertical carousel, the first and second transfer systems can be arranged vertically, i.e., one on top of the other.

One or more items picked from the storage containers are typically placed in one or more delivery containers that are subsequently transported to an outbound area of a fulfilment or distribution centre for delivery to a customer. The control system can be configured to index the plurality of the storage containers around the endless vertical loop such that a target storage container or a vacant carrier is adjacent the transfer conveyance system. For the purpose of definition, the target storage container is a storage container whose contents are required to fulfil a customer order and the vacant carrier is a carrier that is able to retrieve a storage container for storage in the storage and retrieval system.

Instead of transporting the one or more storage containers via the transfer conveyance system to one or more pick station where the contents of the one or more storage containers are picked into one or more delivery containers, the one or more delivery containers can be transported to the at least one vertical carousel where one or more items picked from the storage containers can be placed into the one or more delivery containers in-situ. The one or more delivery containers can be transported to the at least one vertical carousel by the transfer conveyance system or by a mobile device, e.g., a trolley or an autonomously guided mobile device. Optionally, the storage and retrieval system comprises a picking mechanism configured to pick one or more items from the storage container in the deployed position and transfer the one or more picked items to one or more delivery containers. The picking mechanism can be a manual picking mechanism where an operator picks one or more items from a storage container in the deployed position and transfers the picked one or more items to the one or more delivery containers. Optionally, the picking mechanism comprises a picking arm comprising an end effector configured to pick one or more items from the storage container in the deployed position and transfer the one or more picked items to one or more delivery containers either on the transfer conveyance system or the mobile device.

Optionally, the picking mechanism can be mounted to a gantry, said gantry being configured to move the picking arm axially in multiple X and Y orthogonal directions. Once the customer orders are fulfilled in one or more delivery containers, the transfer conveyance system can be configured to transport the one or more delivery containers to the outbound area of the fulfilment centre for subsequent delivery to the customer.

The system may further comprise a load handling device, wherein the load handling device is moveable and operable on the track system, the load handling device comprises a container lifting mechanism for retrieving and/or lowering a storage container through a grid cell or grid space, the container lifting mechanism comprising a grabber device configured to releasably grip a container, and a drive mechanism configured to raise and lower the grabber device. Each load handling device may comprise a vehicle which is arranged to travel in x and y directions on rails of the track system above the vertical carousel. A first set of wheels, consisting of a pair of wheels on the front of the vehicle and a pair of wheels on the back of the vehicle, are arranged to engage with two adjacent rails of a first set of rails. Similarly, a second set of wheels, consisting of a pair of wheels on each side of the vehicle, are arrange to engage with two adjacent rails of the second set of rails. Each set of wheels may be lifted and lowered, so that either the first set of wheels or the second set of wheels is engaged with the respective set of rails at any one time.

When the first set of wheels is engaged with the first set of rails and the second set of wheels are lifted clear from the rails, the wheels can be driven, by way of a drive mechanism housed in the vehicle to move the load handling device in the X direction. To move the load handling device in the Y direction, the first set of wheels are lifted clear of the rails, and the second set of wheels are lowered into engagement with the second set of rails. The drive mechanism can then be used to drive the second set of wheels to achieve movement in the Y direction. In this way, one or more load handling devices can move around the track system above the vertical carousel under the control of the control system. Each load handling device may be provided with means for lifting out one or more containers from an uppermost position in the vertical carousel to access the required products. In this way, multiple products can be accessed from multiple located in the storage and retrieval system at any one time.

The system may comprise both a gantry system and one or more load handling devices. The gantry system and load handling devices may work in cooperation with each other and be controlled by the control system. In one such configuration, the system may comprise two vertical carousels whereby one vertical carousel is adjacent to the other vertical carousel and the gantry system may be arranged directly above one vertical carousel and may lift a desired container from the vertical carousel and transport and deposit the desired container into the adjacent vertical carousel for a load handling device to collect. In another configuration, the gantry system may be arranged directly above a vertical carousel and may lift a desired container from the vertical carousel and transport the desired container to a designated grid cell adjacent to grid cells above the vertical carousel and lower the container into the designated grid cell. The designated grid cell, i.e., the grid cell adjacent to the vertical carousel may act as a port. A load handling device may collect the desired container from the designated grid cell so that the desired container can be transported to a different location, for example, a location where the storage container can be accessed from outside of the grid framework structure or transferred out of the grid framework structure e.g. to a pick station.

Alternatively, the system may comprise only load handling devices for retrieving and/or lowering storage containers through grid cells into the vertical carousel(s), i.e. there is no gantry system in the storage and retrieval system.

Preferably, the storage and retrieval system further comprises a pick station, said pick station comprising a supply zone, an access station and a conveyor system configured to convey one or more containers from the supply zone to the access station, the pick station being located below the track system such that a storage container can be delivered to the supply zone and the storage container can be retrieved from the supply zone via one or more grid cells of the track system. The storage and retrieval system allows a picking device to be instructed to pick up a storage container containing an item of a customer order from a vertical carousel (or a stack of containers) and transport the picked storage container to a pick station whereupon the item can be retrieved from the storage container. A load handling device may transport the storage container to a pick station, and specifically a supply zone of the pick station that is integrated into the grid framework structure. The supply zone may comprise at least one vertical chute configurable to cooperate with at least one upright column, the at least one vertical chute having a first opening for receiving a container lowered by a load handling device or a gantry system through a grid cell and a second opening to allow the container the exit from the supply zone.

The pick station may alternatively be a separate standalone station that is able to receive storage containers from a load handling device or gantry system operative on the grid framework structure. The grid framework structure is able to cooperate with the pick station such that one or more storage containers can be lowered into one or more chutes of the supply zone. A drop off port in the grid can cooperate with a delivery channel in the grid framework structure through which one or more storage containers are transported through the chute for supplying one or more storage containers to the supply zone. Equally, a pickup port in the grid can cooperate with a retrieval channel in the grid framework structure through which one or more storage containers can be picked up from the pick station. Storage containers are fed into the supply zone via at least one chute and are conveyed to a buffer zone where it is vertically accumulated to be picked up by a load handling device or gantry system operative on the grid framework structure. For the purpose of the present invention, “vertical chute” and “chute” are used interchangeably throughout the description to mean the same feature. Alternatively, the pick station may be a separate standalone pick station that is able to receive storage containers from the transfer conveyance system discussed above.

Preferably, the control system and a communication system may keep track of the location of the storage containers and their contents within the storage and retrieval system. The communication system may also allow communication between load handling devices, gantry systems and the vertical carousel(s) such that they can efficiently work together to save time in picking each storage container and/or item from each storage container.

Preferably, the supply zone, the access station, buffer zone and conveyor system are all of a modular construction and can easily be retrofitted to an existing grid framework structure. The one or more chutes allow a load handling device or gantry system operative on the grid framework structure to lower a storage container under gravity and then transport it to an access station, where an operator or a robotic device can gain access to the contents of the storage container. The access station may be operated both as a pick station, where one or more items are picked from a storage container and a restock station (also known as a decant station) where one or more items are deposited into a storage container.

Storage containers delivered to the supply zone may be transported to the buffer zone via the access station by the conveyor system. A storage container is paused at the pick station and an operator selects a required item from a storage container and places it in a customer delivery container. At the buffer zone, the bin lift device lifts a storage container towards the grid such that a load handling device or a gantry system operative on the upper level can retrieve the container. This allows one or more storage containers to be vertically accumulated in the buffer zone. Preferably, a bin lift device lifts the storage container to an uppermost level in the buffer zone above the conveyor system. More preferably, a load handling device or gantry system operative at the upper level is able to grab the storage container in the buffer zone and subsequently lift the storage container.

Preferably, the conveyor system comprises an entry conveyor unit, an exit conveyor unit and at least one access conveyor unit, the entry conveyor unit being arranged in the supply zone and arranged to transport a storage container in a first direction or first transport direction from the second opening of the at least one vertical chute to the at least one access conveyor unit. The exit conveyor unit being arranged in the buffer zone and arranged to transport a storage container from the at least one access conveyor unit to the buffer zone in a second direction or second transport direction, and wherein at least one access conveyor unit being arranged to transport a container from the supply zone to the buffer zone in a third direction or third transport direction. The three conveyor units provide flexibility in terms of reducing the footprint of the pick station assembly to transport one or more containers from the supply zone to the buffer zone via the access station in multiple transport directions. For the purposes of this description, the terms “conveyor” and “conveyor unit” will be used interchangeably. The terms “direction” and “transport direction” are used interchangeably and refer to the direction of transport of a conveyor or a conveyor unit. The terms “first transport direction” and “second transport direction” are used to disambiguate from the terms “first direction” and “second direction” used above with reference to the first and second sets of grid members or tracks.

A method of moving a storage container around the storage and retrieval system is provided. An example storage and retrieval system comprises:
a) a track system for guiding movement of one or more robotic load handling devices, the track system comprising a plurality of grid members to form a grid pattern comprising a plurality of grid cells or spaces;
b) a vertical carousel comprising a drive mechanism for circulating a plurality of containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space;
The method of an example comprises the steps of:
   i) circulating the vertical carousel to position a desired storage container on the vertical carousel at the uppermost position, or to position the vertical carousel such that a storage container can be lowered through a grid cell into the vertical carousel at the uppermost position
   ii) retrieving the desired storage container from the uppermost position through a grid cell, or lowering a storage container through a grid cell into the vertical carousel at the uppermost position.

The method may additionally comprise the step of moving either the desired storage container lifted from the vertical carousel or the storage container to be lowered into the vertical carousel along the track system by means of a load handling device or a gantry system.

The method may comprise steps such that the vertical carousel is capable of being loaded and unloaded through grid cells in the track system. Alternatively, the storage and retrieval system may be arranged such that containers can only be loaded into the vertical carousel through grid cells in the track system, or the storage and retrieval system may be arranged such that containers can only be retrieved from the vertical carousel through grid cells in the track system.

The present invention further provides a method of moving a storage container around a storage and retrieval system, the storage and retrieval system comprising:
a) a track system comprising a plurality of grid members to form a grid pattern comprising a plurality of grid cells or spaces;
b) at least one vertical carousel comprising a drive mechanism for circulating a plurality of containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space;
the method comprising the steps of:
   i) circulating the vertical carousel such that a desired storage container on the vertical carousel is at one or more access positions between the uppermost position and lowermost position of the endless vertical loop for accessing the content of one or more storage containers from the side of the at least one vertical carousel;
   ii) removing the desired storage container from the vertical carousel by moving the desired storage container outwardly relative to the vertical carousel to define a deployed position.

The removing the desired storage container from the vertical carousel by moving the desired storage container outwardly relative to the vertical carousel may involve moving the desired storage container laterally to the side of the vertical carousel.

Optionally, the at least one vertical carousel comprises a plurality of vertical carousels, said plurality of vertical carousels being disposed laterally to each other to form a row of vertical carousels, said control system operatively coupled to the drive mechanism of each of the plurality of vertical carousels to drive each of the plurality of vertical carousels independently or in synchronisation.

### BRIEF DESCRIPTION

These and other aspects of the invention will not be described, by way of example only, and with reference to the accompanying drawings, in which:

FIG. 1 is a schematic diagram of a grid framework structure.

FIG. 2 is a schematic diagram of a top-down view showing a stack of bins arranged within the framework structure of FIG. 1.

FIG. 3 is a schematic diagram of a system of a known robotic load handling device operating on the grid framework structure.

FIG. 4 is a schematic perspective view of the load handling device showing the container receiving space within the body of the load handling device.

FIGS. 5A and 5B are schematic perspective cut away views of the load handling device of FIG. 4, with FIG. 5A showing a container accommodating a container receiving space of the load handling device, and FIG. 5B showing, the container receiving space of the load handling device.

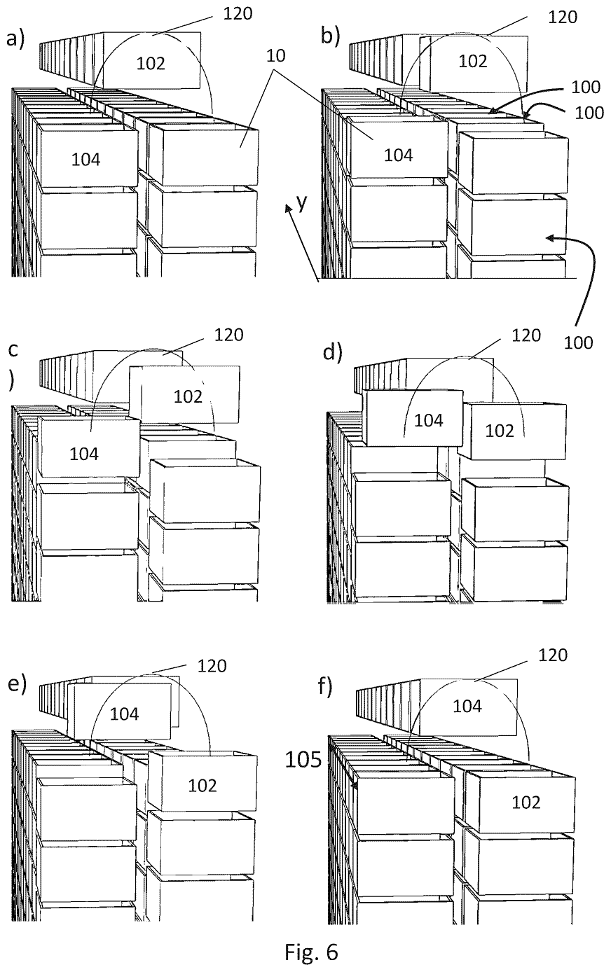

FIG. 6, includes views (a) to (f), which are schematic perspective views of a vertical carousel in operation.

FIG. 7A is an expanded view of a vertical carousel.

FIGS. 7B to 7D are illustrations of the orientation means to keep the orientation of the plurality of carriers in FIG. 7A substantially the same as they circulate around the vertical loop.

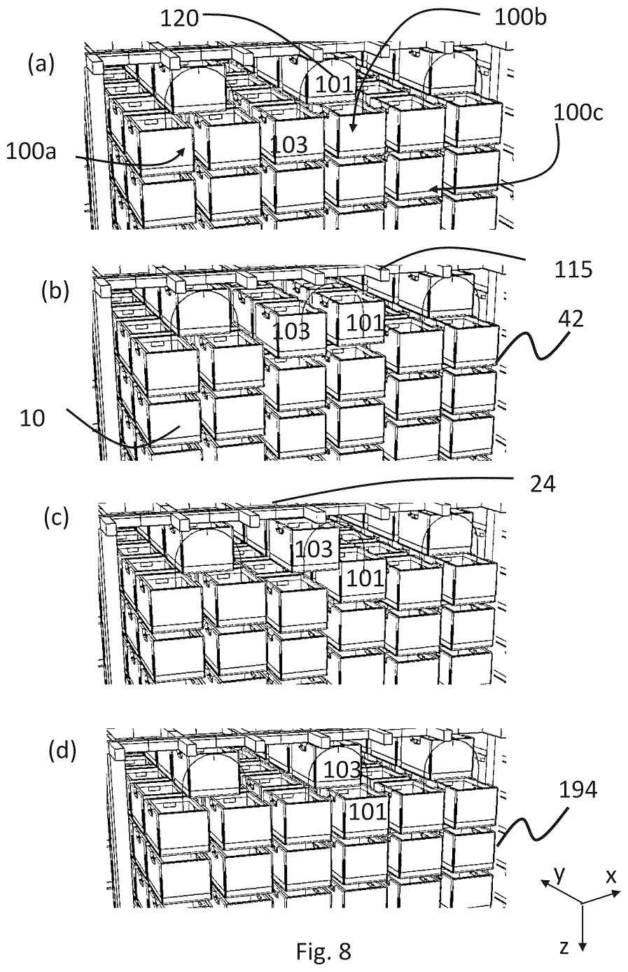

FIG. 8, includes views (a) to (d), which are schematic perspective views of a different configuration of a vertical carousel in operation.

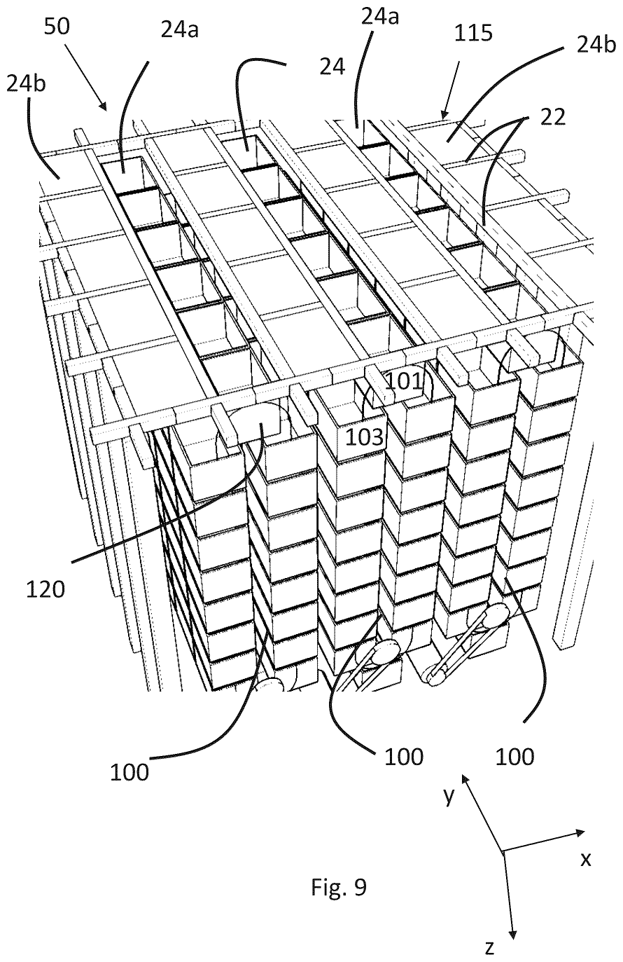

FIG. 9 is a perspective view of a storage and retrieval system comprising three vertical carousels.

FIG. 10 is a top perspective view of a storage and retrieval system comprising three vertical carousels and a load handling device operating on the track.

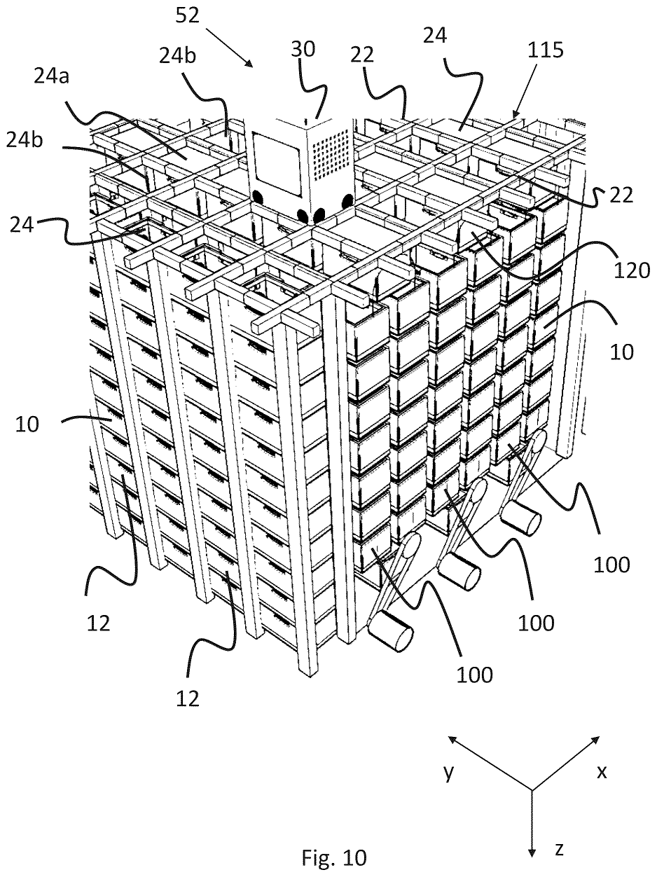

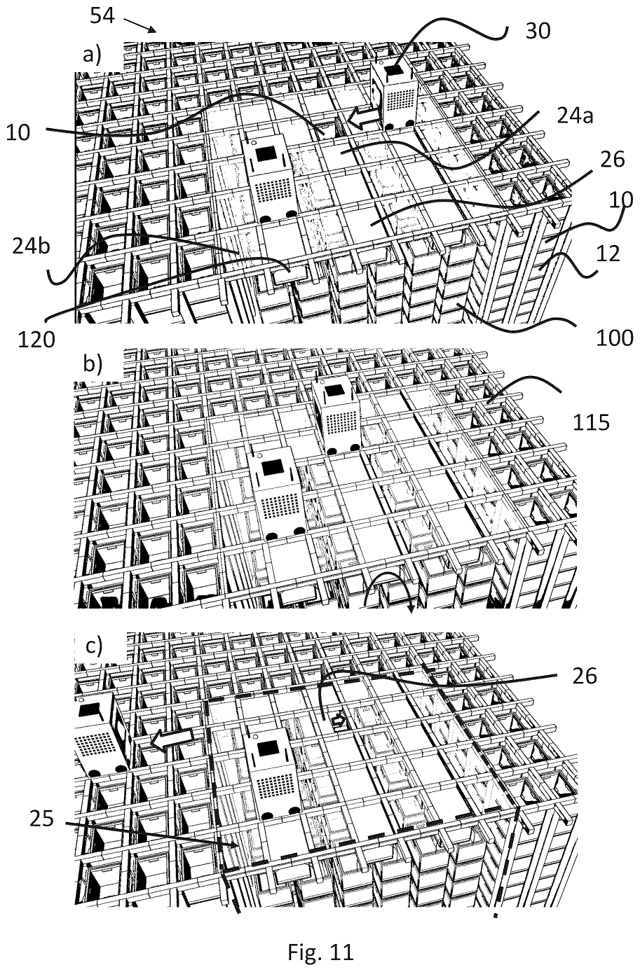

FIG. 11 includes views (a) to (c), which are perspective views of load handling devices operating in combination with three vertical carousels in a storage and retrieval system.

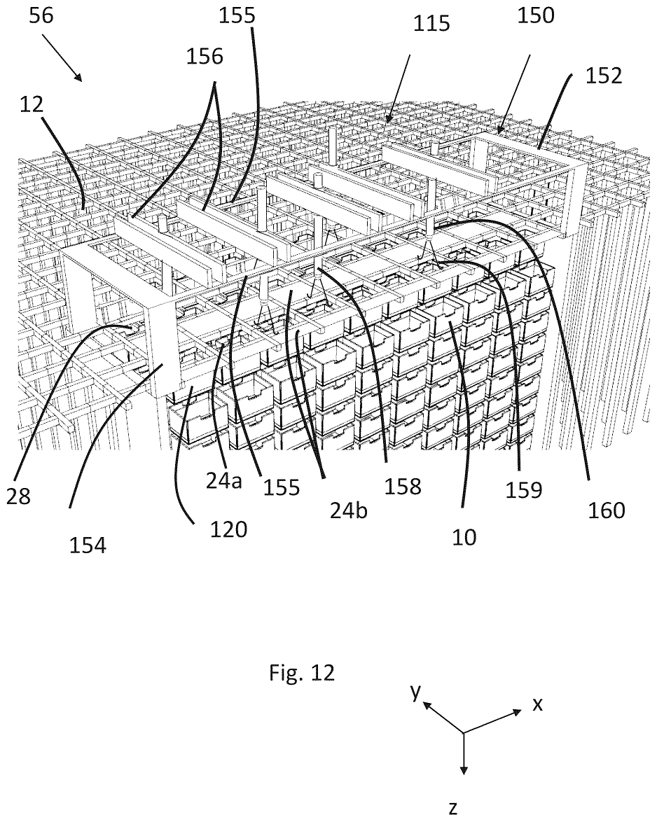

FIG. 12 is a perspective view of a storage and retrieval system comprising a vertical carousel and a gantry system.

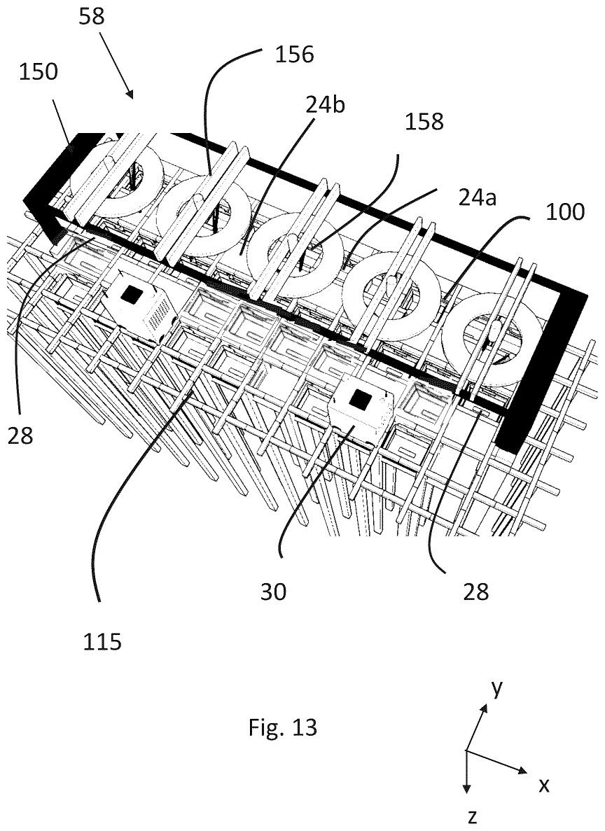

FIG. 13 is a perspective view of a storage and retrieval system comprising a vertical carousel and an alternative gantry system and load handling devices.

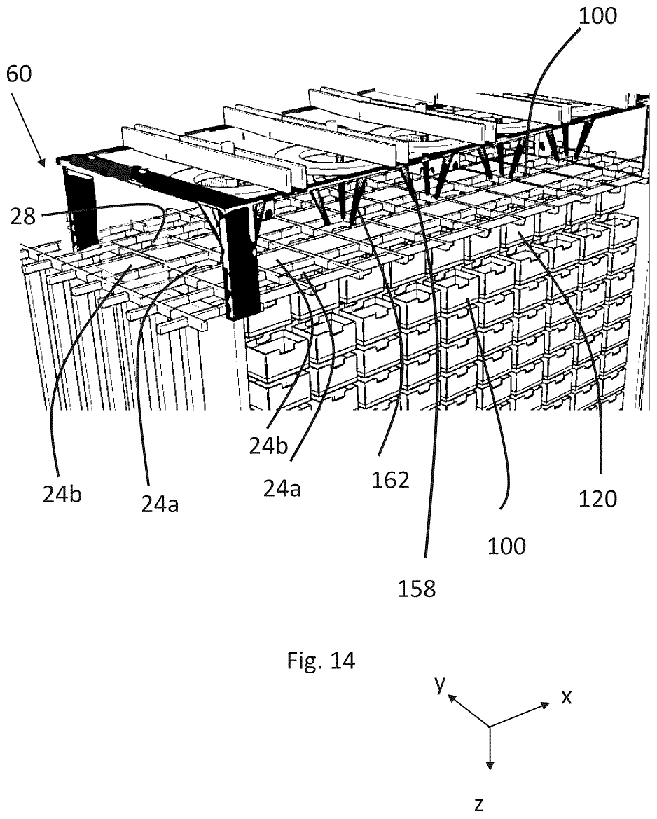

FIG. 14 is a perspective view of a storage and retrieval system comprising two vertical carousels and a gantry system.

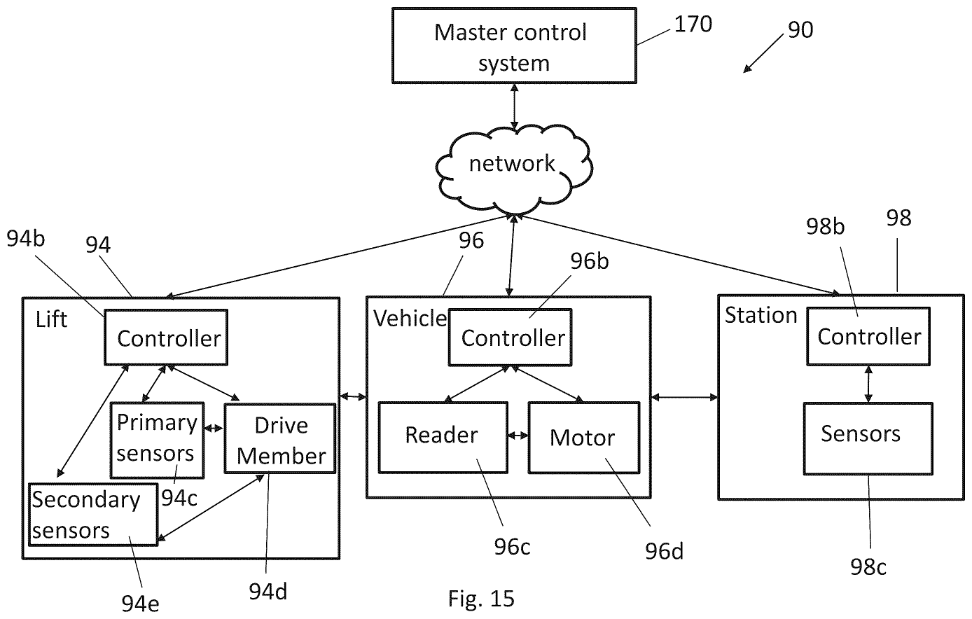

FIG. 15 is a schematic illustration of the components of a control system of a storage and retrieval system.

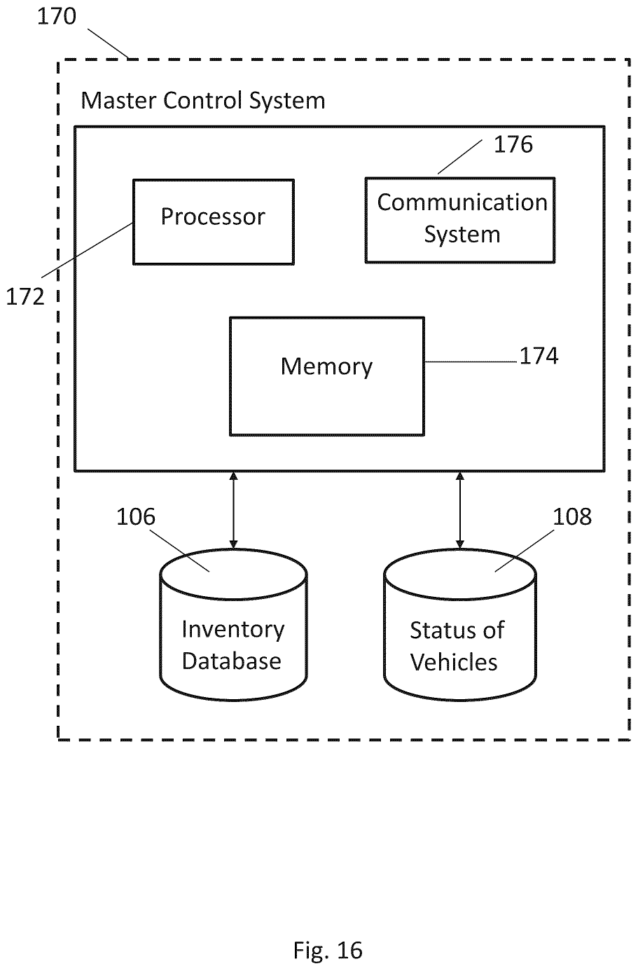

FIG. 16 is a schematic illustration of the components of the master control system shown in FIG. 15.

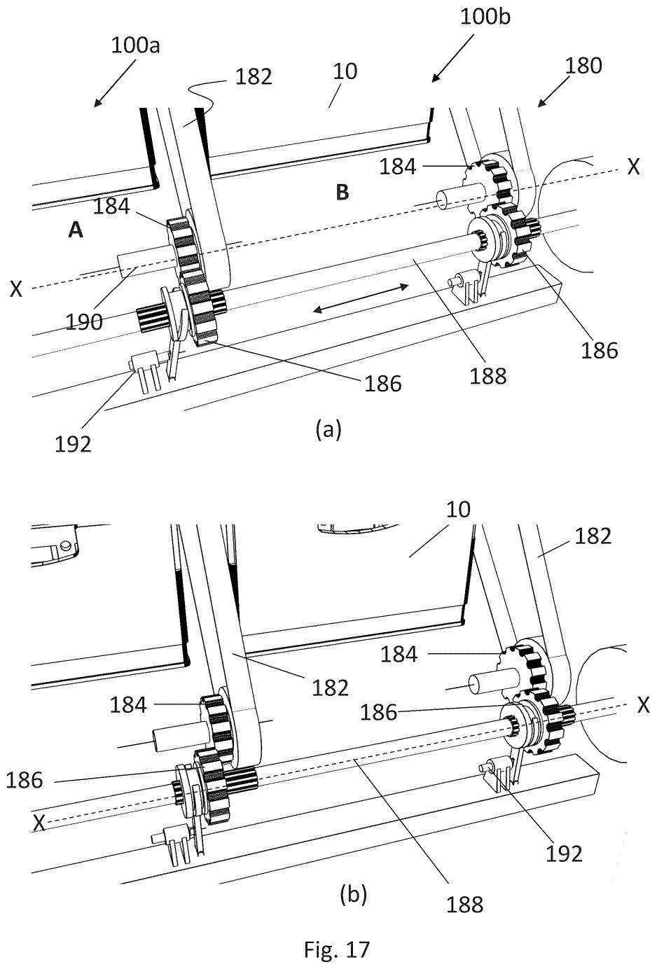

FIG. 17 includes views (a) and (b), which are perspective views of a gearing mechanism for independently engaging with a drive mechanism of a vertical carousel to selectively control movement of the vertical carousel amongst a plurality of vertical carousels where view (a) shows the engagement of the gearing mechanism with the vertical carousel labelled ‘A’; and view (b) shows the engagement of the gearing mechanism with the vertical carousel labelled ‘B’.

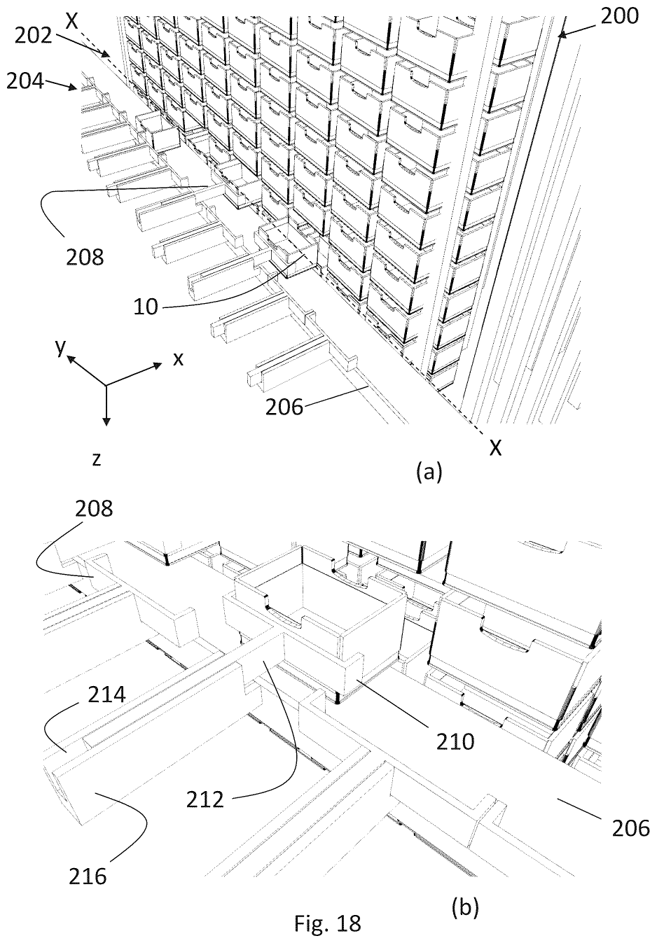

FIG. 18 includes views (a) and (b), which are perspective views of an example of a transfer system comprising a transfer conveyance system and a transfer mechanism disposed laterally to a plurality of vertical carousels, where view (a) shows the transfer mechanism engaging and moving a storage container from a row of a plurality of vertical carousels to a deployed position; and view (b) shows an enlarged view showing the transfer mechanism engaging with the storage container from the row in the plurality of vertical carousels.

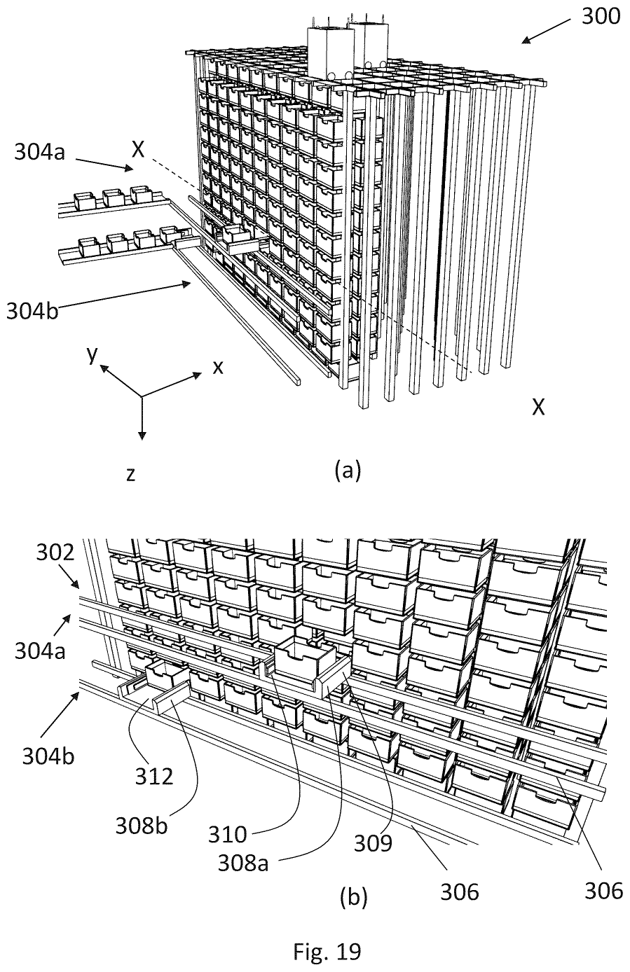

FIG. 19 includes views (a) and (b), which are perspective views of another example of a transfer system comprising a shuttle moveable along one or more tracks, where view (a) shows the shuttle retrieving a storage container from a row of a plurality of vertical carousels; and view (b) shows an enlarged view showing a first shuttle retrieving a storage container from the row in the plurality of vertical carousels and a second shuttle depositing a storage container into a row of the plurality of vertical carousels.

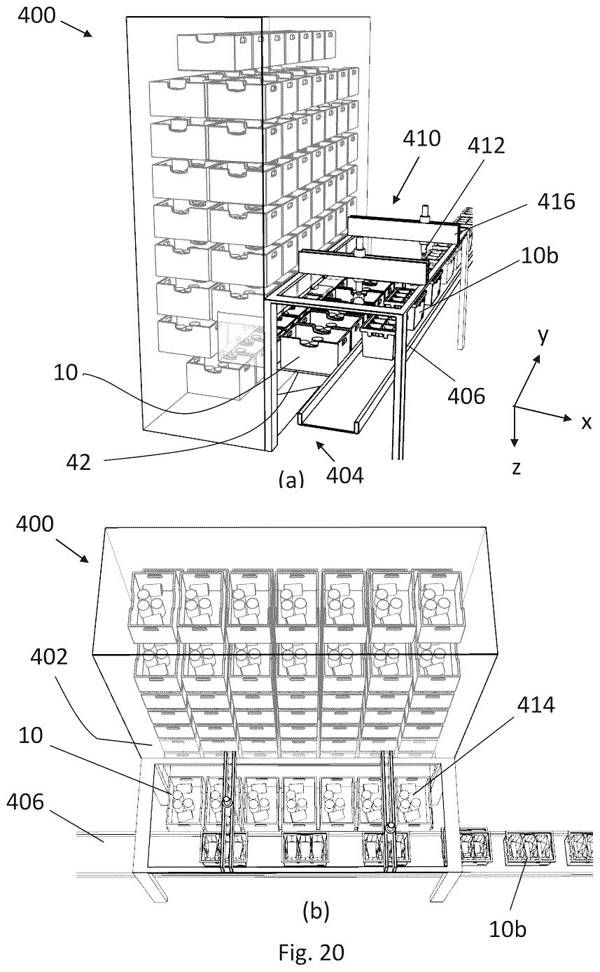

FIG. 20 includes views (a) and (b), which are perspective views of the storage and retrieval system comprising the transfer conveyance system for conveying a plurality of delivery containers lateral to the plurality of vertical carousels and a picking mechanism comprising a picking arm and an end effector for picking one or more items from the storage container in a deployed position and transferring the one or more items to one or more delivery containers on the transfer conveyance system, where view (a) shows a side view of the storage and retrieval system; and view (b) shows a top view of the storage and retrieval system.

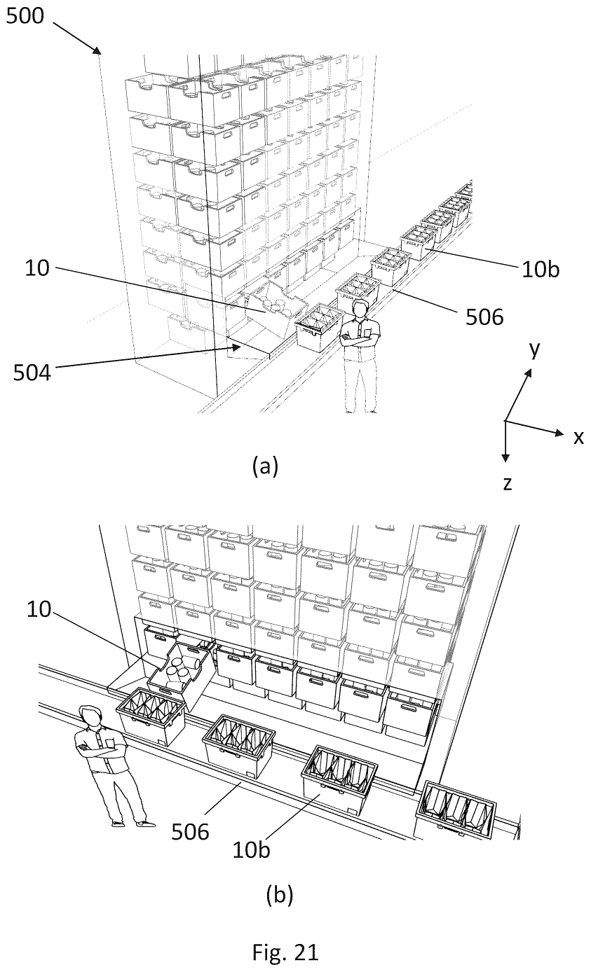

FIG. 21 includes views (a) and (b), which are perspective views of one or more access positions at the side of the vertical carousel between the uppermost and lowermost positions of the vertical endless loop for manually accessing the contents of one or more storage containers in the deployed position and showing the one or more storage containers being tilted in the deployed position to enable easy access by an operator to the contents of the storage containers; where view (a) shows a side view of the one or more storage containers in the deployed position at the access position of the vertical carousel; and view (b) shows the one or more tilted storage containers in the deployed position at the access position from a different angle.

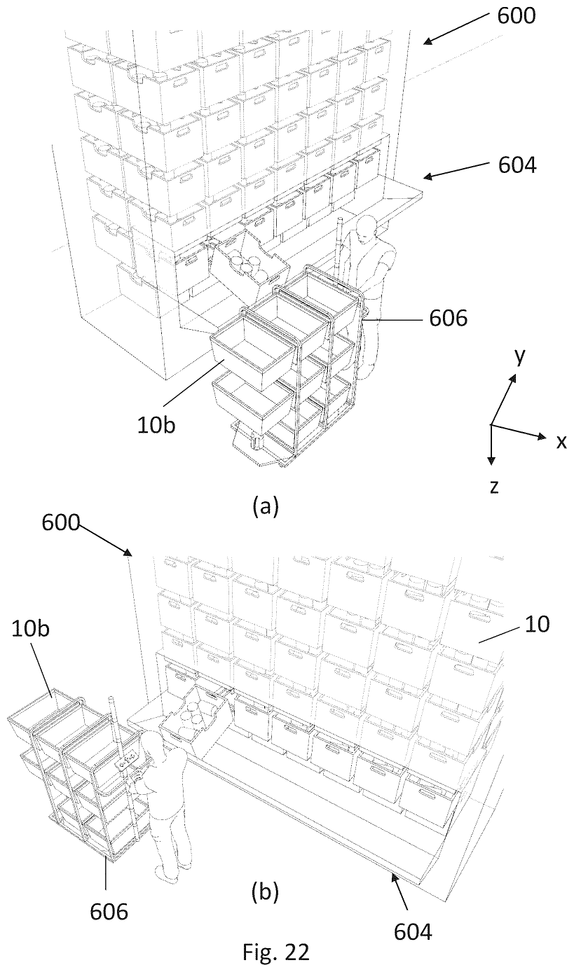

FIG. 22 includes views (a) and (b), which are perspective views of a storage container in the deployed position at the access position where the contents of the storage container are easily transferable by an operator to one or more delivery containers carried by a mobile device; where (a) shows a side view of the storage container in the deployed position at the access position; and (b) shows a top view of the deployed storage container at the access position.

### DETAILED DESCRIPTION

It is against the known features of the storage system such as the grid framework structure and the load handling device described above with reference to FIGS. 1 to 5A and 5B, the present invention has been devised.

Constructional details of vertical conveyors or vertical carousels are known in the art. There are many examples of vertical conveyors or vertical carousels also known as paternosters comprising a chain of open compartments moving continuously in a loop. The present invention incorporates one or more vertical carousels into a storage and retrieval system, such that each vertical carousel is positioned beneath a track system of the system.

There are several different configurations of vertical carousels in a storage and retrieval system. One such configuration is shown in FIG. 6, which includes views (a)-(f). However, all vertical carousels comprise a drive mechanism (not shown) for circulating a plurality of containers 10 around a vertical endless loop from a lowermost position (not shown) to an uppermost position 120 adjacent to a track system (not shown). The drive mechanism is operatively coupled to a control system (not shown) which is configured to index the plurality of containers 10 around the endless vertical loop in sequential steps, each of the sequential steps corresponding to at least one of the plurality of storage containers being aligned with a grid space or grid cell of the track system. In the particular example shown in FIG. 6, views (a) to (f), the plurality of vertical carousels are arranged lateral to each other (e.g., side-by-side) such that the storage containers 10 carried by the plurality of vertical carousels are arranged in one or more rows. The control system can be configured to circulate the plurality of storage containers around their respective vertical endless loops in synchronisation such that each row of storage containers move together in synchronisation. Alternatively, each of the plurality of vertical carousels can circulate independently such that the plurality of storage containers of each of the plurality of vertical carousels move independently. Further detail of the different arrangements of circulation of the storage containers around their respective vertical carousels is discussed below.

By arranging the vertical carousel in this way, storage containers 10 can be picked or lifted from the vertical carousel through the grid cell or grid space above.

Each vertical carousel 100 further comprises a series of carriers (not shown) for accommodating the plurality of storage containers 10. The carriers are maintained in a substantially horizontal orientation as they move from the lowermost position to the uppermost position 120 and vice versa when travelling around in a continuous or endless vertical loop. In particular, the plurality of carriers are coupled to a belt or chain (not shown) which is formed in a continuous or circulating vertical loop and guided by a guide member to form a “paternoster” principle of conveyance, with loading and unloading performed at the uppermost and lowermost points in the loop. The belt or chain is driven to move in a continuous vertical loop by a drive mechanism (not shown), e.g., a motor. Separate drive mechanisms can be used to circulate each of the plurality of vertical carousels or a sub-group of the vertical carousels independently or a single drive mechanism can be used to circulate the plurality of vertical carousels in synchronisation. There are various ways to move a plurality of carriers around a continuous vertical loop. A clutch or gearing mechanism 180 can be used to selectively engage a sub-set of vertical carousels 100a, 100b to the drive mechanism (not shown), wherein the sub-set of vertical carousels comprises one or more vertical carousels. This provides the advantage that a single drive mechanism can be used to circulate a sub-set of vertical carousels. An example of a gearing mechanism 180 for selectively engaging a sub-set of the vertical carousels to the drive mechanism is shown in FIG. 17, views (a) and (b). Each belt or chain 182 of a respective vertical carousel is shown in FIG. 17, views (a) and (b), coupled to an engagement gear or an idle gear 184 that is configured to mesh with a drive gear 186. The drive gear 186 is coupled to the drive mechanism via a drive shaft 188 such that when the drive gear 186 meshes with the engagement gear 184, the vertical carousel is driven to circulate the plurality of storage containers around the vertical endless loop. In the particular example shown in FIG. 17, views (a) and (b), the engagement gear 184 of each of the vertical carousels in a row is connected to their respective belt or chain by being mounted to a respective shaft 190 such that rotation of the shaft 190 by the belt or chain 182 drives rotation the engagement gear 184.

A plurality of spaced apart drive gears 186 are mounted to the single drive shaft 188 and coupled to the drive mechanism. The drive mechanism is configured to drive rotation of the drive shaft 188 and thus, the drive gear 186 about a rotational axis, X-X. To selectively engage one or more vertical carousels to the drive mechanism, one or more of the drive gears 186 coupled to the single drive shaft 188 are actuated to mesh with a respective engagement gear 184 of the vertical carousel. In the particular example shown in views (a) and (b) of FIG. 17, each of the plurality of drive gears are moveable in a longitudinal direction of the single drive shaft 188. Each of the plurality of drive gears can be independently moveable in a longitudinal direction along the drive shaft to selectively mesh with one or more of the engagement gears of the vertical carousel by an actuator 192. Thus, a plurality of actuators 192 can be independently actuated by the control system to selectively actuate a vertical carousel. For ease of explanation, the plurality of drives gears can comprise a first drive gear and a second drive gear. FIG. 17 at view (a) shows the example where the first drive gear meshes with a corresponding first engagement gear to drive the vertical carousel labelled ‘A’ such that rotation of the first drive gear circulates the series of carriers around a vertical loop. FIG. 17 at view (b) shows the example where the first drive gear disengages with the first gear driving the vertical carousel labelled ‘A’ and the second drive gear meshes with a second engagement gear to drive the vertical carousel labelled ‘B’. An exemplary embodiments of different types of vertical carousels are discussed further below.

The containers 10 do not need to be removed when a carrier reaches it uppermost or lowermost position and can be kept on the vertical carousel 100 for a long period of time, until they are picked from the vertical carousel. The carriers of the vertical carousel 100 may comprise a shelf, tray, fork or platform onto which a container can slide or be placed. Each carrier may accommodate a single storage container. Alternatively, each carrier may accommodate a plurality of storage containers, the storage containers being spaced apart such that when each carrier reaches the uppermost position of the vertical carousel, each storage container aligns with each grid cell, so that each storage container can be lifted from the uppermost position of the vertical carousel through a grid cell. The storage containers may be spaced apart from each other on a single carrier by dividers. Each storage container 10 is sized to fit within a single grid cell in a track system.

In FIG. 6, there is shown a series of vertical carousels 100. The vertical carousels are arranged adjacent to each other to form a row of individual vertical carousels 100 extending underneath twelve grid cells of the track system (not shown), i.e., there are twelve vertical carousels shown in FIG. 6. In practice, it is possible to have any number of vertical carousels in a row as space allows or as desired, for example, there may be between five and ten vertical carousels 100 arranged in a row, or there may be between ten and fifteen vertical carousels, or there may be more than fifteen vertical carousels arranged in a row. Each of the vertical carousels is independently controlled and each carrier of each vertical carousel accommodates a single storage container, such that each vertical carousel rotates single storage containers around the vertical loop.

FIG. 6, at view (a), shows a first storage container 102 positioned in an uppermost position 120 such that it is aligned with a grid cell of the track system (not shown). In this position, the first storage container 102 is accessible through a grid cell of the track system. Once the storage container 102 is rotated away from the uppermost position 120, it is no longer accessible via the track system. FIG. 6, at view (b), shows the first storage container 102 being circulated in a clockwise direction, such that it starts to move to the right and downwards. As shown in view (c) of FIG. 6, the first storage container continues 102 to move downwards, whilst a second container 104 moves upwards. In this position, neither the first container 102 nor the second container 104 are accessible by the overlying track system. As shown in. view (c) and (d) of FIG. 6, the first container 102 continues to move downwards, whilst the second container 104 continues to move upwards towards the track system. As shown in FIG. 6 at view (e), the second container 104 nearly reaches the apex or uppermost position 120 of the vertical endless loop, but the second container 104 is only accessible when it is in the uppermost position 120 of the vertical endless loop, as shown in view (f) of FIG. 6.

FIGS. 7A-7D show an example of how the carriers, and therefore the storage containers, may remain horizontal as they circulate around the vertical carousel. As shown in FIG. 7A, the plurality of carriers 42 in the vertical carousel 100 are guided around the vertical loop by a guide member 46 that forms part of a frame 48 of the vertical carousel. In the particular embodiment shown in FIG. 7A, the guide member 46 comprises orientation means 62 so as to maintain the carriers 42 in a substantially horizontal orientation as they transfer from the uppermost position to the lowermost position and vice versa when travelling around the vertical loop. This has the advantage of removing the need to remove a storage container when the carrier reaches the uppermost position or lowermost position as required. Thus, the storage containers can be kept on the vertical carousel for a longer period of time.

The guide member 46 of FIGS. 7A-7D comprises two outer parallel side sections 64 for guiding the corners of each of the plurality of carriers 42 in the upwards and downward direction and opposed end sections 66 for guiding each of the plurality of platforms around the upper and lower portion of the vertical conveyor to complete the loop. Each of the two outer parallel side sections 64 comprises two side sections laterally disposed either side of a centre section which guides the corners of the carriers when travelling in the upward and downward direction. The outer parallel side sections are supported by a frame 48 comprising parallel upright members 52. To keep each of the plurality of carriers in a substantially horizontal orientation when traveling around the vertical loop, each of the plurality of carriers are moveably coupled to a drive member 44 (e.g., a chain or a belt) such that each of the plurality of carriers is able to pivot relative to the drive member 44 when the drive member changes direction at an uppermost and lowermost portion of the vertical carousel. Thus, when travelling around the curvature portion of the drive member 44 at the uppermost and lowermost portion of the vertical carousel 100, to maintain each of the plurality of carriers 42 substantially horizontal as the drive member changes direction at the uppermost and lowermost portion of the vertical carousel, each of the plurality of carriers pivots about the coupling with the drive member 44 about a substantially horizontal axis extending through the coupling.

In the particular example shown in FIG. 7A, the orientation means comprises a bracket 68 (or hanger) so that each of the plurality of carriers 42 are moveably coupled to the drive member 44 via the bracket 68. The brackets 68 are pivotally coupled to the drive member 44, e.g., a chain or belt, and each of the plurality of carriers 42 are fixedly coupled to each of the brackets 68. The drive member 44 drives the plurality of carriers 42 around a vertical loop. To maintain each of the plurality of carriers 42 in a substantially horizontal orientation as they travel at the uppermost and lowermost portions of the vertical carousel, each of the brackets 68 is pivotally coupled to the drive member 44 such that the bracket rotates about a horizontal axis extending through the coupling as the drive member changes direction around the curvature portions of the vertical carousel 100.

To prevent each of the plurality of carriers 42 from swinging about the horizontal axis when the drive member 44 changes direction, the bracket 68 comprises at least two vertically spaced guide pins 70, 72. The at least two vertically spaced guide pins comprise an upper guide pin 72 and a lower guide pin 70. The guide pins 70, 72 each cooperate with the corresponding vertically spaced guide paths (upper guide path 46b and lower guide path 46c) having a similar curvature as the drive member at the uppermost and lowermost portions of the vertical carousel such that the bracket 68 is guided by the at least two vertically spaced guide paths 46b, 46c at the uppermost and lowermost portions of the vertical carousel. As shown in FIG. 7B, the two vertically spaced pins 70, 72 are guided by two guide paths 46b, 46c one above the other, more specifically two semi-circular guide paths at the upper and lower portion of the vertical carousel that merge into a single guide path 46 between near the uppermost and lowermost positions of the vertical carousel. In other words, the separation between the two guide paths changes as the drive member changes direction from an upward direction to a downward direction and vice versa, whereby the separation increases as the drive member increasingly changes direction. Maximum separation occurs at the uppermost and lowermost point of the guide member. The at least two vertically spaced guide pins 70, 72 are preferably vertically spaced in an axial direction, i.e. aligned on the same vertical axis. The mechanism by which the orientation means maintains the orientation of the carriers in a substantially horizontal orientation at the uppermost and lowermost portions of the vertical carousel is now described in reference to FIGS. 7C to 7D.

FIG. 7C shows the bracket 68 which supports a carrier 42 (shown in FIG. 7A) approaching the uppermost position of the vertical carousel where the guide path 46 separates into the two guide paths 46b, 46c and the upper guide pin 72 of the vertically spaced guide pins enter the upper guide path 46b. As the direction of the upper guide path changes 46b due to its curvature, the upper guide pin 72 engages with the upper guide path 46b. This causes the bracket 68 to shift laterally in the direction of the curvature of the upper guide path 46b as shown in FIG. 7D. This in turn causes the lower guide pin 70 to enter the lower guide path 46c as demonstrated in FIG. 7D. Further movement of the upper guide pin 72 driven by the drive member drives the upper 72 and lower guide pins 70 into their respective upper 46b and lower guide paths 46c as shown in FIG. 7D. The cooperation of the lower guide pin 70 with the lower guide path 46c prevents the platform changing orientation. When exiting the uppermost portion of the vertical carousel, the upper and lower guide pins 70, 72 enter into the guide path 46 as the upper and lower guide paths 46b, 46c merge into the single guide path 46.

In the particular example shown in FIGS. 7A-7D, the bracket 68 is mounted to the drive member at opposing sides and centrally of each of the plurality of carriers 42. The bracket 68 is fixed at two points on each of the plurality of carriers 42 to ensure that the carriers are kept in the same orientation as the bracket 68 is driven around the vertical loop. The bracket 68 is substantially V-shaped. The guide member 46 comprise two outer parallel side sections 64 in addition to the guide path 46 disposed between the side sections 64 for maintaining the horizontal orientation of the carriers as they change direction at the uppermost portion and lowermost portion of the vertical carousel as discussed above. In operation when moving from an upward direction to a downward direction, each of the plurality of carriers 42 decoupled from the parallel outer side sections 64 at the upper and lower portion of the vertical carousel is carried by the drive member 44 around the centrally mounted guide path 46 in order to keep the carriers in a substantially horizontal orientation as they change direction.

The arrangement of the vertical carousels in FIGS. 6 and 7A-7D is such that the storage containers and/or carriers moving towards or away from the uppermost position 120 are positioned partly beneath the uppermost position in order to reduce the width of the vertical carousel. The storage containers are arranged such that, aside from the container in the lowermost position which is positioned completely directly beneath the uppermost position, approximately one half of each container moving towards or away from the uppermost position is directly beneath the uppermost position 120. This results in the vertical carousel occupying a width of two grid cells in the grid framework structure.

In another configuration, each vertical carousel may comprise a carrier that accommodates a row of storage containers. This is shown in FIG. 8, which includes views (a) to (d). Specifically, views (a) to (d) of FIG. 8 show three vertical carousels 100a, b, and c arranged adjacent to each other in the x-direction and the centre vertical carousel is shown moving in a loop. While the carriers are not shown, views (a) to (d) of FIG. 8 show how a row of storage containers 10 on a single carrier move around a loop. In FIG. 8 at view (a), the second (or, central) vertical carousel 100b is positioned such that the uppermost carrier and therefore a first row 101 of storage containers 10 is positioned at an uppermost position 120 aligned beneath a row of grid cells 24 (the row extending in the y-direction) in the track system 115. In view (b) of FIG. 8, the second vertical carousel 100b moves clockwise such that the carriers and therefore the rows of storage containers 10 move in unison. The first row 101 of storage containers 10 in the second vertical carousel 100b circulates in a clockwise direction to allow a second row 103 of a storage containers 10 in the vertical carousel to move into the uppermost position 120 of the second vertical carousel 100b. This means that upon each sequential step, a new row of storage containers 10 on the carrier, in this case, the second row 103 of containers 10, is aligned with a row of grid cells 24 in the track system 115 such any one of the storage containers 10 in the second row 103 positioned at the uppermost position 120 can be lifted through a grid cell 24 directly above the container.

Each carrier for the vertical carousels 100 of FIG. 8 accommodates a plurality of storage containers. The carrier may be segmented to allow each storage container to accommodate a particular region of the carrier, and to ensure better alignment of each storage container under each grid cell when the carrier is in the uppermost position 120 of the loop.

In FIG. 8, only the second vertical carousel (also called the central or center vertical carousel) 100b is shown moving. The other two vertical carousels 100 (called the first vertical carousel 100a and the third vertical carousel 100c) may also circulate independently of the second vertical carousel 100b. The first vertical carousel 100a and third vertical carousels 100c may circulate in unison whilst the second vertical carousel 100b operates independently of the other two vertical carousels. Alternatively, all three vertical carousels 100a, 100b, 100c may circulate together at the same speed.

FIG. 9 shows an embodiment of a storage and retrieval system 50 comprising a track system 115 and a plurality of vertical carousels 100 of the type shown in FIG. 8. The track system 115 comprises a plurality of grid members, tracks or rails 22 arranged in a grid pattern comprising a plurality of grid cells or grid spaces 24. Beneath the grid cells or grid spaces 24 are vertical carousels 100 arranged so that containers can be lifted through the grid spaces or grid cells 24. The uppermost position 120 of each vertical carousel 100 aligns with a grid cell or grid space 24.

The vertical carousels are arranged such that the carriers extend in the y-direction, meaning that rows of storage containers extend in the y-direction. The vertical carousels also extend in the x-direction, whereby at least one half of each container moving towards or away from the uppermost position is directly beneath the upper position 120, resulting in each vertical carousel occupying a width (in the x-direction) of two grid cells (specifically, a grid cell and two half grid cells). In the example of the storage and retrieval system shown in FIG. 8, the vertical carousel has a footprint that only extends across two grid cells of the track system, e.g., a pair of grid cells of the track system. The arrangement of the vertical carousel beneath the track system results in two types of grid cells: access grid cells 24a and non-access grid cells 24b. The words ‘access grid cells’ and ‘non-access grid cells’ are used to describe only the grid cells positioned directly above the vertical carousel(s) (i.e., the words are not used to describe grid cells in which stacks of containers are stored in any of the storage and retrieval systems described in this application). The access grid cells and non-access grid cells have same size and shape as each other, but differ in terms of how they are used. The access grid cells 24a are grid cells through which a container can be lifted from the uppermost position 120 of the vertical carousel 100, or lowered into the uppermost position 120 of the vertical carousel 100. Specifically, the access grid cells 24a are located directly above the uppermost position 120 of the vertical carousel 100. The non-access grid cells 24b are grid cells that do not allow access to the uppermost position 120 of the vertical carousel. The non-access grid cells 24b may be covered, as shown in FIG. 8. As shown in FIG. 9, the access grid cells 24a are arranged such that they alternate with the non-access grid cells 24b along the width-wise direction (x-direction) of the vertical carousels. Because the storage and retrieval system 50 of FIG. 8 comprises three vertical carousels 100, there are three rows of access grid cells 24a extending in the y-direction, and four rows of non-access grid cells 24b also extending in the y-direction. The access grid cells 24a alternate with the non-access grid cells 24b along the x-direction. As the carriers of the vertical carousels shown in FIG. 9 extend in the y-direction, the rows (extending in the y-direction) of access grid cells 24a alternate with the rows (extending in the y-direction) of non-access grid cells 24b in the x-direction (along the width of the vertical carousels).

The advantage of the vertical carousel having a footprint that extends only two grid cells is the ability to have a close packed arrangement of storage containers. Moreover, the densely packed arrangement of the vertical carousels, each of the vertical carousels having a footprint that extends across only two grid cells, complements a load handling device having a footprint that occupies a single grid cell. The plurality of vertical carousels 100 can be arranged so as to provide a plurality of rows of storage containers 194 as shown in FIG. 8. To increase the storage capacity of the storage and retrieval system, the height of each of the vertical carousel is greater than its width. This allows each of the plurality of vertical carousels 100a, 100b, 100c to accommodate a plurality of carriers 42 in a vertical direction and thereby, having the ability to densely store a plurality of storage container vertically below the track system. The greater the height of each of the plurality of vertical carousels, the greater the number of carriers that can be accommodated in a vertical direction.

When a plurality of vertical carousels are arranged side by side or lateral to each other as shown in FIG. 9, a close packed arrangement of storage containers can be achieved as shown in FIG. 8. Like a cubic storage system known in the art, the plurality of storage containers can be envisaged to be stored in one or more stacks below the track system and therefore, having a storage capacity close to the cubic storage system. For example, the locations of the storage containers in the storage and retrieval systems can be indicated using co-ordinates in three dimensions to represent the load handling device or a container's position and a container depth (e.g., container at (X, Y, Z), depth W). Equally, locations in the storage and retrieval system may be indicated in two dimensions to represent the load handling device or a container's position and a container depth (e.g., container depth (e.g., container at (X, Y), depth Z). Each branch of the vertical endless loop can be compared to a stack of storage containers in a traditional grid framework structure. In contrast to the grid framework structure known in the art comprising a plurality of storage columns, Z=1 identifies the uppermost layer of the vertical endless loop, i.e., the layer immediately below the track system, Z=2 is the second layer below the track system and so on to the lowermost, bottom layer of the vertical endless loop.

The system of FIG. 9 is arranged such that all three vertical carousels 100 can rotate in synchronisation with each other, i.e., they can be rotating at the same speed and indexing the containers 10 in sequential steps at the same time. Alternatively, each vertical carousel may be individually controlled and may only be rotated when a picking device is nearby. In the particular example shown in FIG. 9, each of the vertical carousels 100 is coupled to a respective drive mechanism (not shown). Alternatively, the plurality of vertical carousels can be driven by a single drive mechanism. A gearing or clutch mechanism discussed above can be implemented to selectively engage one or more of the vertical carousels to the single drive mechanism. One or more actuators can be actuated to engage the one or more of the vertical carousels to the drive mechanism.

FIG. 10 shows a storage and retrieval system 52 which is similar to the storage and retrieval system 50 shown in FIG. 9, except that the storage and retrieval system 52 in FIG. 10 comprises both vertical carousels 100 and stacks 12 of containers 10. In FIG. 10, there are three vertical carousels 100 in the storage and retrieval system 52 and the stacks 12 of containers 10 are arranged along one side (extending in the y-direction) of the storage and retrieval system 52. Each stack 12 is aligned with a grid cell or grid space 24 and storage containers 10 can be accessed in the conventional way, i.e., by a “digging” process if necessary, as explained in relation to FIG. 3.

FIG. 10 also shows a picking means in the form of a load handling device 30 which is operable and moveable on the tracks 22. The load handling device, as shown in FIG. 10 has the same dimensions as a single grid cell, but it is also possible to have a load handling device sized such that it extends over more than one grid cell. The load handling device 30 is able to move in both x and y directions across the tracks 22 of the track system 115 and lift a storage container from a stack 12 or from an uppermost position 120 in a vertical carousel 100 through a grid space 24. The load handling device may lift a storage container through a grid cell 24 from either the uppermost position 120 of a vertical carousel 100 or from a stack 12 of containers 10 by using a gripper device 39 as shown in FIGS. 5A-5B as known in the art. The load handling device may also lower a storage container through a grid cell 24 into an uppermost position 120 of a vertical carousel 100 or onto a stack 12 of containers. In this way, storage containers 10 can be moved around the storage and retrieval system 52.

FIG. 11 includes views (a) (c), which show a similar storage and retrieval system to FIG. 10 but viewed from a higher perspective. The storage and retrieval system 54 of FIG. 11, views (a)-(c), comprises stacks 12 of containers 10 as in the conventional system shown in FIG. 3. The storage and retrieval system 52 of FIG. 11 also comprises three vertical carousels 100 arranged under a track system 115. The storage and retrieval system 54 of FIG. 11 differs from the storage and retrieval system 52 of FIG. 10 in that the storage and retrieval system 54 of FIG. 11 has a different distribution of stacks 12 of containers 10 around the vertical carousels 100, such that there are more stacks of containers surrounding the vertical carousels 100. In another embodiment of the invention, each vertical carousel 100 may be separated by one or more rows of stacks 12 of containers 10.

In FIG. 11, the three vertical carousels 100 are arranged adjacent to each other. This allows the vertical carousels 100 to be enclosed together in an insulated environment 25, shown as the volume within the dashed lines in FIG. 11 at view (c). The insulated environment 25 may be kept at a cooler temperature than the rest of the storage and retrieval system 54, for example, the insulated environment may be at a temperature for storing chilled items, e.g., 0° C. to 5° C. or the insulated environment may be at a temperature for storing frozen items, e.g.,-23° C. to −18° C. In order to keep the area as cool as possible, the access grid cells 24a of the track system 115 in the insulated environment 25 each comprise a door 26. The door 26 of a grid cell 24a opens when a load handling device 30 is instructed by the control system (not shown) to move to the grid cell 24a to retrieve a container 100 from the grid cell or grid space. The control system may thus instruct both the movement of the vertical carousel 100, the movement of the load handling device 30 and the opening and closing of the doors 26 of the access grid cell 24a. In FIG. 11 at view (a), a load handling device 30 is instructed to move to access grid cell 24a, so the door 26 of the access grid cell 24a is opened to allow the load handling device 30 to access the desired container at the uppermost position 120 of the vertical carousel 100. The load handling device 30 may wait on the access grid cell 24a, as shown in FIG. 11 at view (b), while the vertical carousel 100 circulates, or the desired storage container may be already in position at the uppermost position 120 ready for a load handling device 30 to lift the desired container from the vertical carousel 100. The load handling device 30 lifts the desired storage container using a grabber device 39 of the type shown in FIGS. 5A-5B. Once the load handling device 30 removes the desired storage container from the uppermost position 120 of the vertical carousel 100, the load handling device 30 moves along the track system 115 away from the access grid cell 24a and the door 26 of the access grid cell 24a closes, as shown in FIG. 11 at view (c). Specifically, as shown in view (c) of FIG. 11, the door 26 is slidable from one side of the access grid cell to the other. Alternatively, it is possible that the doors 26 may be hinged and may pivot about the hinge.

It is also possible to input storage containers 10 into the storage and retrieval system 54 of FIG. 11. A load handling device carrying a storage container moves along the track system 115 towards an access grid cell 24a. The vertical carousel located beneath the access grid cell 24a circulates the carriers to a position where the storage container can be lowered through the access grid cell 24a into the uppermost position of the loop of the vertical carousel. Specifically, there needs to be a space in a carrier at the uppermost position and the space needs to be directly beneath the access grid cell 24a on which the load handling device is positioned. Alternatively, the load handling device 30 can move to an access grid cell 24a which is above a space in a carrier at the uppermost position. The load handling device 30 can then lower the storage container 10 through the access grid cell 24a into the space in the carrier. Thus, the load handling devices 30 operative on the track system can both put storage containers into the vertical carousels and take storage containers out of the vertical carousels.

FIG. 12 shows an alternative arrangement of a storage and retrieval system. The storage and retrieval system 56 of FIG. 12 is different to the storage and retrieval systems of FIGS. 9, 10 and 11, because in the storage and retrieval system 56 of FIG. 12 there is only one vertical carousel 100. The vertical carousel 100 is arranged such that its longitudinal length (which can accommodate a single row of containers) extends in the x-direction, in contrast to the arrangement of the vertical carousels shown in FIGS. 9, 10 and 11. The arrangement of the vertical carousel 100 in FIG. 12 allows a full row of containers 10 on a carrier to be visible from the side of the storage and retrieval system 56. The vertical carousel 100 in FIG. 12 accommodates ten containers 10 in a single row and/or carrier. Surrounding three sides of the vertical carousel 100 are stacks 12 of containers. An advantage of arranging a plurality of vertical carousels so that a full row of storage containers on a carrier are visible from the side of the storage and retrieval system is the ability to retrieve or deposit a storage container into or from the side of the plurality of vertical carousels in contrast to through a grid cell as discussed above. Further detail of retrieving or depositing a storage container to or from the side of the storage and retrieval system is discussed below.

The storage and retrieval system 56 of FIG. 12 further differs from the storage and retrieval systems of FIGS. 9 to 11 in that the storage and retrieval system 56 of FIG. 12 comprises a gantry system 150. The gantry system 150 comprises a gantry crane or frame 152 which straddles a portion of the track system 115. Specifically, the gantry frame 152 straddles the grid cells 24 located above the vertical carousel 100 (i.e., a row of access grid cells 24a, and an inner and an outer row of non-access grid cells 24b) and a further row of grid cells adjacent to the inner row of non-access grid cells 24b. In FIG. 12, the outer row of non-access grid cells 24b is not formed as a full row of grid cells since it is on the periphery of the storage and retrieval system 56, so is instead formed as a partially formed row of grid cells. However it is possible for the outer row of non-access grid cells 24b to be formed as a full row of grid cells. It is also possible for the gantry frame 152 to extend over a larger area of the track system 115, for example, across the grid cells above multiple vertical carousels, or across the entire track system of a storage and retrieval system. The gantry crane or frame 152 comprises gantry legs 154 extending upwards from the track system. Alternatively, one or more gantry legs 154 may extend upwards from the floor. FIG. 12 shows a gantry crane 152 comprising four gantry legs 154. Beams 155 are positioned on top of the uppermost ends of the gantry legs 154 such that the beams 155 extend along the length (x-direction) of the track system 115. In FIG. 12 there are two beams 155, each beam 155 being supported by the gantry legs 154. The beams 155 may comprise an I-shaped cross-section (not shown). The beams 155 are reinforced to support horizontal loads. A plurality of cross girders 156 are positioned perpendicular to the beams 155 and extend between the two beams 155. In FIG. 12, the gantry system 154 comprises five cross girders 156. Each cross girder 156 may be stationary or may be moveable along the beams 155, such that each cross girder 156 moves in the x direction and traverses across a portion of the track system 115. While a plurality of cross girders 156 are shown in FIG. 12, there may be a single cross girder in the gantry system 150 which is moveable along the entire length (x-direction) of the gantry system 154. Each of the plurality of cross girders allows storage containers to be moved around in a specific area of the track system.

Connected or attached to each cross girder 156 is a container lifting mechanism 158 for lifting and lowering a storage container from or into a stack or an uppermost position 120 in a vertical carousel 100. FIG. 12 shows the container lifting mechanism 158 (also termed a ‘lifting mechanism’) as a gripper device 159 extending from a moveable, extendable and retractable arm 160. Any similar device can be used that can lift and lower a storage container, for example a hoist may be used. Alternatively, the gantry system may comprise a gantry robot or Cartesian robot or linear robot. Each moveable, extendable and retractable arm 160 in the storage and retrieval system 56 of FIG. 12 moves or slides along the cross girder 156 it is connected to, such that the arm 160 moves in the y-direction. The cross-girder 156 is also moveable in the x-direction along the beams 155 (i.e., movement of the cross-girder is perpendicular to the movement of the container lifting mechanism), so a particular container lifting mechanism 158 may operate in an area of 4 by 4 grid cells, for example. As shown in FIG. 12, each container lifting mechanism operates across a portion of a row of port cells 28. Whilst not shown in FIG. 12, the storage and retrieval system 56 of FIG. 12 may additionally comprise load handling devices of the type shown in FIGS. 4, 5A-5B, 10 and 11. The row of port cells 28 is accessible to load handling devices and the gantry system. The gantry system can drop off storage containers in a port cell 28 for a load handling device to pick up the storage container and transport it to a different location in the storage and retrieval system. Alternatively or additionally, a load handling device may deposit a storage container in the port 28 for the gantry system to pick up the storage container and deposit it into the vertical carousel, specifically an empty carrier or empty portion of a carrier which is positioned at the uppermost position of the loop/vertical carousel. This arrangement for the interaction between load handling devices 30 and a gantry system 150 is shown more clearly in FIG. 13.

FIG. 13 shows a storage and retrieval system 58 which is similar to the storage and retrieval system of 56 of FIG. 12, except that the storage and retrieval system 58 of FIG. 13 uses a gantry system 150 having a different container lifting mechanism 158, and load handling devices 30 are shown near to the gantry system 150. The container lifting mechanism 158 comprises a gantry robot 162 which is moveable in the x, y and z directions. The gantry robot 162 is shown more clearly in FIG. 14. The container lifting mechanism 158 may also be moveable along the cross-girder 156 onto which it is connected.

FIG. 13 shows the position of the row of port cells 28 which are adjacent to the non-access grid cells 24b and accessible to both the gantry system 150 and the load handling devices 30. The container lifting mechanism 158 can lift a container 10 from the vertical carousel 100 beneath the track system 115 and deposit it in a port cell 28 for a load handling device 30 to collect and transport to another location, for example a pick station.

While FIGS. 12 and 13 show a single vertical carousel 100 in a storage and retrieval system, it is possible to have multiple vertical carousels in a storage and retrieval system comprising a gantry system 150. This is shown in FIG. 14. In the storage and retrieval system 60 of FIG. 14, there are two vertical carousels 100 located adjacent to each other and on the periphery of the storage and retrieval system 60. The rows of access grid cells 24a and non-access grid cells 24b can be seen on the track system 115. In addition, there is a row of port cells 28 adjacent to the inner row of non-access grid cells 24b, usable in the same way as used in the storage and retrieval systems 56, 58 of FIGS. 12 and 13. The gantry system 150 straddling across the two vertical carousels adjacent each other and a row of port cells 28 allows the container lifting mechanism 158 to pick a container from either one of the two vertical carousels 100 and deposit it in a port cell 28 for collection by a load handling device. Similarly, a load handling device can deposit a storage container in a port cell 28 and the container lifting mechanism 158 in the form of the gantry robot 162 can pick up the storage container, move it and lower it through an access grid cell 24a into an empty carrier or portion of a carrier positioned at the uppermost position 120 of either one of the vertical carousels. It is also possible for a storage container to be moved from one vertical carousel to the adjacent vertical carousel using the gantry system 150, and in particular allowing the gantry robot 162 to pick up the desired storage container, which may require the gantry robot 162 to move along its associated cross-girder 156, and deposit the storage container in an empty carrier or portion of a carrier in the uppermost position 120 of the other vertical carousel. While FIG. 14 shows the gantry system 150 extending over two vertical carousels and a row of port cells 28, it may also be possible for the gantry system 150 to extend over three, four, five or more vertical carousels. Alternatively, the storage and retrieval system may comprise only vertical carousels for storing storage containers, i.e. the storage and retrieval system may be free from stacks 12 of containers.

Each vertical carousel 100 is controllable by a control system which additionally controls the gantry system 150 and, if present, any load handling device(s) 30, such that each vertical carousel 100 circulates and pauses such that the container 10 comprising the desired item is positioned at an uppermost position 120 of the vertical carousel 100 to allow the container 10 to be lifted from vertical carousel 100 through an access grid cell 24a. Alternatively, the vertical carousels may circulate continuously pausing as each container reaches the uppermost position of the vertical carousel.

An illustration of an example of a control system 90 for operating the storage and retrieval systems described above is shown in FIG. 15. The components of the storage and retrieval system such as the vertical carousel 100, the load handling devices 30 and/or gantry system 150, a pick/decant station 98 are controlled by a master control system 170 comprising one or more processors 172, a memory 174 for storing instructions executed by the one or more processors and a communication module 176 for communicating with the one or more load handling device 30 and/or gantry system 150 and the vertical carousel 100.

FIG. 15 is an exemplary embodiment of the master control system 170 showing one or more processors 172, the communication system 176 and the memory device 174. The master controller system 170 can be a standalone server or web server where data is processed in the cloud. The one or more processors may include one or more known processing devices. The communication system 176 may be configured to allow data to be received and/or transmitted by the master controller system to and from the one or more load handling devices 30 and/or gantry system 150 and/or the vertical carousel 100 and/or the pick/decant station (not shown). The one or more processors 172 and memory 174 storing instructions when executed by the one or more processors cause the one or more processors to control the storage and retrieval system, namely the vertical carousels (referred to as “lift” in FIG. 15), the load handling devices and the gantry system (both the load handling devices and/or the gantry system are referred to as “vehicle” in FIG. 15) and the pick/decant station (referred to as “station in FIG. 15). The communication system 176 is equipped with suitable transmission and receiving means (i.e., a transmitter—receiver system) to enable transmission and reception of signals to and from the load handling devices 30 and/or gantry system, the vertical carousel(s) 100 and the pick/decant station. The master control system 170 typically communicates with the vertical carousel(s), load handling devices 30 and/or gantry system 150 and the pick/decant station 98 over a network by wireless communication means.

FIG. 15 illustrates how a vertical carousel 94 (of any of the types previously described) operates together with the master control system 170. The vertical carousel 94 comprises a lift controller 94b in communication with one or more primary sensors 94c for sensing the presence of a storage container. The one or more primary sensors 94c can be present at each of the plurality of carriers such that the one or more primary sensors can sense the presence of a storage container on the carrier. Not shown in FIG. 15, the vertical carousel can comprise a communication system (not shown) configured to send and receive instructions from the master control system 170. The instructions are executed by the lift controller 94b. The one or more primary sensors 94c can be an optical sensor or alternatively a camera for detecting the presence of a storage container on a carrier. Signals from the one or more primary sensors 94c are either processed by the lift controller 94b to cause movement of the plurality of carriers and/or sent to be processed by the master control system 170 to provide instructions to the lift controller 94b to cause movement of the plurality of carriers.

In the configuration where one or more load handling devices and/or a gantry system deposits storage containers into an uppermost position of the vertical carousel, the master controller 170 controls how the load handling devices and/or gantry system interact with the vertical carousel. If all the carriers are occupied, the load handling devices and/or gantry system is instructed to wait until a carrier becomes available. The vertical carousel will determine whether one or more empty carriers have reached the uppermost position of the loop, and the vertical conveyor will pause to allow the load handling device and/or gantry system to deposit the storage container into the uppermost position of the vertical carousel via a grid cell. The vehicle controller 96b communicates with the lift controller 94b via the communication module and provides instructions to the lift controller 94b when to pause movement of the vertical carousel. Alternatively, the vertical carousel can continually rotate at the constant speed, pausing as each carrier reaches the uppermost position of the vertical loop. In this configuration, the vehicle controller communicates with the lift controller 94b via the communication module and provides instructions on when the load handling device and/or gantry system can deposit and/or retrieve a storage container from the vertical carousel, and through which grid cell.

The master control system 170 controls the alignment of the carriers at the uppermost position with the grid cells in the track system above the vertical carousel. As shown in FIG. 15, the vertical carousel 94 comprises one or more secondary sensors 94e present at each of the plurality of carriers such that the one or more sensors can sense whether the carrier is aligned with the grid cell in the track system above. The one or more secondary sensors 94e can be optical sensors or alternatively a camera for detecting the alignment of a carrier at the uppermost position of the vertical loop with the access grid cell above. If the one or more secondary sensors 94e detect that the carrier at the uppermost position in the loop is not aligned with the adjacent access grid cell, the one or more secondary sensors 94e send a signal to the master control system 170 to provide instructions to the lift controller 94b to cause movement of the plurality of carriers by the drive member 94d. In contrast to the primary sensors 94c which sense the presence of a storage container in the carrier and therefore send signals to the master control system 170 which leads to indexing of storage containers around the vertical loop, the secondary sensors 94e sense whether or not the carriers and storage containers are aligned with the grid cells in the track system above and therefore send signals to the master control system 170 which leads to the drive member 94d making minor adjustments in the position of the carriers and thereby storage containers supported by the carriers. Specifically, the master control system 170 instructs the lift controller 94 to move the drive member 94d such that the carrier and storage container in the uppermost position in the vertical loop move by less than a grid cell to allow the storage container to be retrieved by a load handling device 30 or gantry system 130 via the access grid cell.

In an alternative embodiment, the secondary sensors may be positioned within the vicinity of an access grid cell in the track system through which the storage containers can be retrieved from the vertical carousel or deposited into the vertical carousel. In this configuration, the secondary sensors within the vicinity of the access grid cell can send signals to the master control system 170 which provide instructions to the controller 94b to adjust the position of the carrier using the drive member 94b, such that a storage container can be retrieved from or deposited into the uppermost position of the vertical carousel via the access grid cell. The master controller system may be connected to one or more databases 106, 108 e.g., over the network. The one or more databases 106, 108 may include data associated with inventory and/or the position of the items of inventory in the vertical carousel (and stacks if present in the storage and retrieval system) and/or frequency of requested items. In the particular embodiment shown in FIG. 16, the master controller system is in communication with an inventory database 106 and a database 108 concerning the status of load handling devices and/or gantry system (herein referred to as “vehicles” in FIG. 15). The status includes the position of the load handling devices and gantry system within and around the storage area, the engagement of the load handling devices and/or gantry system with the vertical carousel(s) and the health status of the load handling devices and/or gantry system e.g., battery life, faults etc. The inventory database 106 provides data of the type of items in storage e.g., data associated with a (SKU) stock keeping unit of an item and the amount/weight of items in storage. Different SKUs can be held in storage containers which are stored on carriers in the vertical carousel(s). Each of the storage containers in storage can be labelled with an electronic label or an identified that identifies the SKU held in the storage container and/or the amount of the SKU, e.g., weight. The label or identifier can be a barcode, QR code or other electronic label which is able to hold data associated with the SKU or type of item held in the storage container and/or position of the storage container in the vertical carousel(s). The label on the storage containers can be read by a reader 96c mounted on the load handling device and/or gantry system and communicated to the master control system 170. The label on the storage containers can alternatively, or additionally be read by a reader mounted in the vicinity of the grid cell (specifically an ‘access grid cell’) through which a storage container can be deposited or lifted from the vertical carousel and the position of the storage container can be communicated to the master control system 170.

Each of the load handling devices and/or gantry systems comprises a vehicle controller 96b for executing instructions received from the master control system, a reader 96c and a communication module. The reader 96c is configured to read the markers e.g., barcode readers, QR code of the storage containers. Specifically, if the load handling device or gantry system is positioned on an access grid cell, it can read the markers of the storage containers as the vertical carousel circulates and indexes the storage containers beneath the track system. The communication module is configured to send the signals from the reader to the master control system 170. The signals from the readers 96c in the load handling devices and/or gantry system or alternatively or additionally the sensors mounted in the vicinity of the access grid cell are used by the master control system to instruct the load handling device and/or gantry system to activate the gripper device to retrieve the desired storage container from the vertical carousel through the grid cell. If only the sensors mounted in the vicinity of the access grid cell identify a desired storage container at an uppermost position on the vertical carousel, the sensors send a signal to the master control system 170 which instructs the controller 96b of the load handling device or gantry system to operate the motor of the load handling device or gantry system 96d such that the load handling device or gantry system can retrieve the desired storage container from the vertical carousel. The load handling device or gantry system can then transport the desired storage container to a pick station 98 where one or more items can be picked from the storage container. Alternatively, if the readers do not detect a signal, this identifies to the master control system that there is an empty space on the carrier, and therefore the master control system may instruct a load handling device and/or gantry system to deposit a storage container in the empty space on the carrier.

If the load handling device and/or gantry system has retrieved a desired storage container from the vertical conveyor, it will transport the desired storage container to a pick station 98. The load handling device or gantry system may transport the desired storage container directly to the pick station 98, or as described previously, a gantry system may transport the storage container to a port cell 28 where it is retrieved by a load handling device which moves the desired storage container to the pick station 98. On arrival at the pick station, the load handling device or gantry system sends a signal to the pick station 98 of arrival so that an operator at the pick station or a robotic handling device can retrieve the item from the storage container. The pick controller 98b or the load handling device or gantry system can then send a signal to the master control system 170 of the availability of the load handling device or gantry system of the availability for another retrieval. As the storage container moves through the pick station, the position of the storage container is identified by sensors 98c within the pick station. The pick station can double up as a decant station or in-feed station for replenishing stock in the inventory. Thus, the storage container from which one or more items were picked can go back into the vertical carousel along with other storage containers containing items temporarily located in the pick station. Disposed between the vertical carousels and the pick/decant station is a pickup port in the grid framework structure through which one or more storage containers can be picked up from the pick station by a load handling device operative on the grid framework structure. The storage container can then be moved around the grid framework structure with the load handling devices and/or the gantry system and fed into the vertical carousel as described above.

In addition to or instead of transferring a storage container vertically through a grid cell by a load handing device operable on the track system or a gantry as discussed above when a target storage container carried by the vertical carousel reaches its uppermost position, one or more target storage containers can be accessible from a position at least one side of the vertical carousel. For the purpose of the present invention, the term “target” in respect to one or more containers is used interchangeably with the term “desired”. The one or more accessible positions at the at least one side of the vertical carousel can be defined as an access position 202. For the purpose of the present invention, the access position represents a position of the vertical carousel where one or more storage containers are accessible from the side of the vertical carousel and is between the uppermost and lowermost positions of the vertical carousel, i.e., at least one external face of a plurality of vertical carousels. When a plurality of vertical carousels are arranged in rows, the plurality of storage containers extending across the plurality of vertical carousels are arranged in one or more rows and can represent the one or more access positions of the storage and retrieval system. In the particular embodiment shown in FIG. 18, views (a) and (b), one or more rows of storage containers are accessible from the at least one side of the plurality of vertical carousels 202. To move one or more target storage containers to the access position 202 for retrieving a storage container from the side of the plurality of vertical carousels, each of the plurality of vertical carousels 202 is arranged to circulate the plurality of storage containers about a rotational axis, X-X. The control system (e.g., lift controller), discussed above, can control the circulation of the plurality of storage containers around the vertical endless loop in sequential steps such that one or more fresh or target storage containers are at their respective access position. For example, this may involve circulating one or more storage containers from their uppermost or lowermost positions to a position on at least one side of the vertical carousel.

In addition to or separately to sensing whether the carrier is aligned with the grid cell in the track system discussed above, the one or more secondary sensors can sense whether one or more carriers is at the access position. The one or more secondary sensors 94e can be one or more rotational sensors for sensing rotation of the drive mechanism of the vertical carousel. Examples of such rotational sensors include but are not limited to an encoder that determines the revolution of the vertical endless loop. In response to a signal from the one or more secondary sensors, the control system can determine the position of one or more storage containers or even one or more carriers relative to the access position. When a target storage container or a target carrier is requested for fulfilling a customer order, the control system, in particular the master control system, can determine the position of the target storage container or target carrier relative to the access position 202 and then instruct the drive mechanism to drive rotation of the vertical endless loop such that the target storage container is at the access position of the vertical carousel. In the case where the one or more secondary sensors comprise a rotational sensor, the control system determines an angle of rotation of the vertical endless loop to circulate the vertical endless loop such that the target storage container or the target carrier is at the access position.

As discussed above, a sub-set of the plurality of vertical carousels can be independently actuated to circulate the plurality of storage containers around their respective vertical endless loops or the plurality of vertical carousels can be actuated in synchronisation such that one or more of the storage containers are at their respective access positions. For the purpose of explanation of the present invention, a sub-set of the plurality of vertical carousels can comprises one or more vertical carousels. The control system can be configured to index one or more of the plurality of storage containers around their respective vertical endless loop in sequential steps, wherein each of the sequential steps correspond to one or more of the plurality of storage containers being at their respective access positions.

To access the contents of one or more storage containers from the one or more access positions, the storage and retrieval system can comprise a transfer system 204 for transferring one or more storage containers to or from the side of the vertical carousel. The transfer system 204 is laterally disposed to the plurality of vertical carousels 200; more specifically at one or more access positions 202 of the plurality of vertical carousels. When aligned with the access position, the transfer system 204 can be controlled to transfer one or more storage containers between a stowed position in the vertical carousel and a deployed position. For the purpose of definition of the present invention, the stowed position represents the position where the storage container 10 is supported by a carrier in the vertical carousel. To transfer a storage container to the deployed position can involve extracting the storage container outwardly of the vertical carousel such that the contents of the storage container is accessible. Transfer of a storage container between the stowed and the deployed position can be done manually by a simple push and pull technique or by an automated mechanism. Further detail of the automated mechanism to transfer the storage container between the stowed and deployed position is discussed below. The control system (e.g., lift controller) can be configured to circulate the plurality of storage containers such that one or more storage containers are aligned at the transfer system 204. The transfer system may comprise a transfer conveyance system 206 for transporting one or more storage containers in a direction parallel to the rotational axis, X-X, of one or more of the plurality of vertical carousels and, optionally, a transfer mechanism 208 for transferring a storage container between the stowed position in the vertical carousel and the deployed position on the transfer conveyance system 206. In the deployed position, the storage container is removed from the vertical carousel In the particular example shown in FIG. 18(a and b), the transfer conveyance system 206 comprises at least one conveyor. Various conveyance systems known in the art can be used to transport one or more storage containers in a direction parallel to the rotation axis, X-X of one or more of the plurality of vertical carousels. These could be but are not limited to a belt or chain driven conveyor or a plurality of rollers. In the particular example shown in FIG. 18, views (a) and (b), the transfer conveyance system is a belt driven conveyance system 206.

Views (a)-(b) of FIG. 18 show an example where the transfer mechanism 208 is an automated transfer mechanism. The transfer mechanism, optionally, comprises a grabber mechanism 210 extendible in a direction substantially perpendicular to the rotational axis, X-X, of the vertical carousel or in a direction substantially perpendicular to the transport direction of the transfer conveyance system to retrieve or deposit a storage container to or from the vertical carousel. Various grabber devices known in the art can be used to engage the storage container stowed in the vertical carousel. In the particular embodiment of the present invention, the grabber mechanism is shown comprising a clamp for clamping onto the sidewalls of the storage container and transferring the storage container onto the transfer conveyance system. Various actuators can be used to control the movement of the clamp towards or away from the storage container at the access position of the vertical carousel. These include but are not limited to the use of a linear actuator, hydraulic means, telescopic mechanism or a gearing mechanism, e.g., a rack and pinion gearing mechanism. The actuator is configured to move the clamp across the transfer conveyance system to engage with the storage container. In the particular example shown in FIG. 18, view (b), the clamp is connected to an elongated arm 212 telescopically receivable in a channel 214 of a support member 216 and moveable in a longitudinal direction along the channel towards or away from the storage container. Once engaged with the storage container, the grabber mechanism 210 retracts to move the storage container to the deployed position (i.e., remove the storage container from the vertical carousel) and onto the transfer conveyance system 206.

Movement of the grabber mechanism to retrieve or deposit a storage container onto the transfer conveyance system 206 can be controlled by the control system for controlling the circulation of the plurality of storage containers around the vertical endless loop or a separate control system (e.g., a grabber controller). In conjunction with controlling the circulation of the plurality of storage containers around the vertical endless loop, the control system can be configured to instruct the grabber mechanism, more specifically, the actuator to deposit or retrieve a storage container to or from the vertical carousel at the access position. When retrieving a target storage container from the vertical carousel at the access position, the grabber mechanism engages with the target storage container and pulls the target storage container to the deployed position such that the target storage container can be brought onto the transfer conveyance system. The transfer conveyance system may subsequently transport the target storage container to a pick station (not shown), discussed above, where the contents of the target storage container are picked to fulfil a customer's order. Once the items are picked, the target storage container may be returned for storage in the vertical carousel via the transfer conveyance system. This could be the same vertical carousel that the target storage container was retrieved from or a different vertical carousel and largely, depends on the vacancy of the carriers of the vertical carousel. The one or more primary sensors, discussed above, can sense whether a carrier is vacant or occupied by sensing the presence of storage container on the carrier.

When depositing a storage container into the vertical carousel, the control system can instruct the vertical carousel to circulate the plurality of carriers such that when a vacant carrier is at the access position, the grabber mechanism can simply be instructed to push the storage container onto the vacant carrier. For the purpose of the present invention, a vacant carrier is a carrier that is not carrying a storage container. In response to the one or more sensors discussed above, the control system can coordinate or orchestrate the movement of the transfer conveyance system and the circulation of the carriers around the vertical endless loop such that a storage container is adjacent or is aligned with a vacant carrier at the access position. Linear movement of the grabber device in a direction perpendicular to the rotational axis, X-X, of the vertical carousel pushes the storage container onto the vacant carrier. Depositing one or more storage containers into the vertical carousel can also involve re-stocking one or more items into one or more vertical carousels. Items decanted into the one or more storage containers are transported to the vertical carousels via the transfer conveyance system. In addition to the primary and secondary sensor discussed above, one or more tertiary sensors can be used to determine the position of the storage container on the transport conveyance system. Examples of the tertiary sensor include but are not limited to various optical sensors such as retro-reflective sensors or diffuse sensors. Thus, in response to signals from the primary, secondary and tertiary sensors, the control system can coordinate the movement of the vertical carousel and the transfer conveyance system such that a target storage container stowed in the vertical carousel is aligned with the transfer conveyance system or a vacant carrier is aligned with the transfer conveyance system, i.e., at the access position. When aligned with the transfer conveyance system, the control system can instruct the transfer mechanism to either retrieve a target storage container from the vertical carousel or push a storage container onto a vacant carrier.

To cater for a plurality of vertical carousels, the storage and retrieval system can, optionally, comprise a plurality of transfer mechanisms 208. The plurality of transfer mechanisms are spaced apart in a longitudinal direction of the transfer conveyance system 206 such that each of the plurality of transfer mechanisms is positioned to retrieve or deposit a storage container to or from a respective vertical carousel. For each of the plurality of transfer mechanisms to stow or deploy one or more storage contains into a respective vertical carousel, the spacing between each of the transfer mechanisms can correspond to the spacing between each of the plurality of vertical carousels. Each of the plurality of transfer mechanisms is actuated by the master control system to retrieve or deposit a storage container to or from a respective vertical carousel in response to a signal from the primary, secondary and the tertiary sensors.

While the particular embodiment shown in FIG. 18 in views (a) and (b) show a single transfer system to retrieve or deposit one or more storage containers into or from one or more vertical carousels, the present invention is not limited to a single transfer mechanism and can comprise a plurality of transfer mechanisms. For example, the storage and retrieval system can comprise a first transfer system configured to retrieve a storage container from a vertical carousel and a second transfer system configured to deposit a storage container into the vertical carousel; each of the first and second transfer systems comprises a respective first and second transfer conveyance systems and a respective first and second transfer mechanisms. The control system can control the first and second transfer systems to coordinate the movement of their respective transfer mechanisms and transfer conveyance systems to retrieve and deposit storage containers to and from one or more vertical carousels.

In contrast to having a separate transfer mechanism to retrieve or deposit a storage container into the vertical carousel and a transfer conveyance system to transport the storage container to a pick station, the transfer mechanism can also transport one or more storage containers to or from a pick/decant station. In the particular embodiment shown in FIG. 19, in views (a) and (b), the transfer mechanism 308a, 308b of the transfer system 304a, 304b is moveable across one or more vertical carousels 300 to access a target storage container at the access position 302 of a target vertical carousel. The transfer mechanism 308 are shown in FIG. 19, views (a) and (b) comprises a shuttle 309 moveable along one or more tracks 306 extending in a longitudinal direction parallel to the axis of rotation, X-X, of the plurality of vertical carousels. Once at the target storage container, the transfer mechanism 308 is configured to retrieve the target storage container from its carrier, i.e., remove the target storage container from the vertical carousel. The shuttle 309 comprises a support deck 312 for supporting a storage container. Retrieval of the target storage container involve moving the target storage container to the deployed position, i.e., in a direction substantially perpendicular to the transport direction of the shuttle onto the support deck 312 of the shuttle 308. The shuttle 308 may comprise a grabber device 310, as discussed above, that is configured to engage the target storage container and withdraw the target container from its carrier. There are various grabber mechanisms known in the art to engage the target container and move the target storage container in a lateral direction to the deployed position. These include but are not limited to a clamp discussed above with reference to FIG. 18, views (a) and (b). Alternatively, the carrier for supporting the storage container may comprise a conveyor unit configured to move the storage container onto the shuttle. Once transported onto the support deck 312 of the shuttle, the shuttle is moveable along the one or more tracks 306 to a pick station where the contents of the storage container can be accessed to fulfil a customer order.

In addition to retrieving one or more target storage containers at the access position of the one or more vertical carousels, the shuttle can be configured to deposit one or more storage containers into one or more vertical carousels, e.g., re-stocking one or more vertical carousels with one or more items. This can be carried out by the same shuttle used to retrieve the storage container or a different shuttle. In the particular embodiment shown in FIG. 19, views (a) and (b), the storage and retrieval system comprise a first transfer system 304a to retrieve a storage container from a vertical carousel and a second transfer system 304b to deposit a storage container into the vertical carousel. In contrast to the transfer system described above with reference to FIG. 18, views (a) and (b), the first and second transfer systems 304a, 304b comprise first and second shuttles 308a, 308b moveable along their respective one or more tracks. The first shuttle 308a is configured to retrieve a storage container from a vertical carousel and the second shuttle 308b is configured to deposit a storage container into the vertical carousel. In all of the above examples, the storage container retrieved from the vertical carousel is transported to a pick station remote from the vertical carousel where the contents of the storage contents are picked to fulfil a customer order. Typically, one or more items that are picked from the one or more storage containers to fulfil one or more customer orders are placed into one or more delivery containers in an outbound area of a fulfilment or distribution centre. The delivery containers are used to store the picked items when being transported to a customer's destination.

In contrast to transporting the storage container to a pick station remote from the vertical carousel to fulfil a customer order in one or more delivery containers, picking of one or more items to fulfil one or more customer's orders can be carried in situ at the vertical carousel. In another embodiment of the present invention shown in FIG. 20, views (a) and (b), one or more delivery containers 10b can be transported to the vertical carousel 400 where items for fulfilling a customer order can be picked from a storage container 10 retrieved from the vertical carousel and placed into the one or more delivery containers 10b in situ. In the embodiment shown in FIG. 20, views (a) and (b), the storage and retrieval system comprise a picking mechanism 410 comprising a picking arm 412 comprising an end effector for picking one or more items 414 from the storage container 10 in the deployed position. Thus, instead of the transfer conveyance system 406 being configured to transport one or more storage containers to or from the vertical carousel, the transfer conveyance system can, optionally, be configured to transport one or more delivery containers 10b to the vertical carousel for fulfilling one or more customer orders.

Retrieval of a target storage container from the vertical carousel may involve extracting the target storage container from its carrier at the access position 402 to the deployed position. The transfer mechanism may simply involve manually pulling the target storage container from the vertical carousel. The carrier can be configured to move forwards and downwards from the stowed position to the deployed position at a lower vertical level than the stowed position. For example, the carrier 42 supporting the storage container can be mounted to one or more telescopic rails to enable a storage container to be pulled from the stowed position in the vertical carousel to the deployed position. Alternatively, the transfer mechanism can be automated and can comprise a motorized system that is configured to automatically extract the target storage container from the stowed position to the deployed position, e.g., the grabber device as discussed above. In both cases, the deployed position represents a position of the storage container where the contents of the storage container can easily be accessed by the picking mechanism 410. To enable the contents of the storage container to be easily accessible when in the deployed position, the open end of the storage container is exposed to the picking mechanism.

Various end effectors known in the art can be used to pick one or more items from the storage container when in the deployed position. Examples of the end effector include a jaw gripper, a finger gripper, a magnetic or electromagnetic gripper, a Bernoulli gripper, a vacuum suction cup, an electrostatic gripper, a van der Waals gripper, a capillary gripper, a cryogenic gripper, an ultrasonic gripper, and a laser gripper. Manipulation of the end effector to pick one or more items from the storage container retrieved from the vertical carousel can be carried by a picking arm, e.g., a robotic arm.

One or more items 414 picked from the storage container are transferred to one or more delivery containers 10b in situ. To transfer the one or more picked items to one or more delivery containers in situ, one or more delivery containers are transported to a position within the reach of the picking mechanism 410. For the picking mechanism to be within reach of the storage container in the deployed position and the delivery container on the transfer conveyance system, the transfer conveyance system can be arranged such that, when in the deployed position, the storage container is interposed between the plurality of vertical carousels 400 and the transfer conveyance system 406. This allows the end effector mounted to the picking arm 412 to be able to pick up one or more items from the storage container in the deployed position and transfer the one or more items to a delivery container paused on the transfer conveyance system. In the particular example shown in FIG. 20, views (a) and (b), the picking arm 412 and the end effector mounted thereon are moved in multiple orthogonal directions, namely X, Y and/or Z Cartesian directions by being mounted to a gantry 416. In addition to moving the end effector in multiple orthogonal axes, the end effector can optionally be rotated about a vertical axis. The gantry is shown comprising a frame that extends across the storage container in the deployed position and the transfer conveyance system. To automate the picking process from the storage container in the deployed position to the delivery container on the transfer conveyance system to fulfil one or more customer orders, the picking arm is configured to move between the storage container in the deployed position and the transfer conveyance system. The picking arm can be a six-axes robot or a SCARA robot (Selective Compliance Assembly Robot Arm or Selective Compliance Articulated Robot Arm). In comparison to the six-axes robot, the SCARA robot provides faster speed and greater reach to the one or more items in the storage container. To further automate the picking process, the transfer mechanism can be automated to move the storage container between the stowed position and the deployed position. For example, the carrier supporting the storage container in the stowed position may comprise a drive roller or belt that is configured to move the storage container outwardly relative to the vertical carousel to the deployed position.

In response to one or more signals from one or more sensors, the control system can be configured to coordinate the movement of the transfer conveyance system and the picking mechanism such that one or more items can be picked and transferred from a storage container in the deployed position to a delivery container delivered by the transfer conveyance system. For ease of explanation, the transfer conveyance system can be defined as a delivery conveyance system. In the case where the transfer mechanism is automated, the control system can additionally instruct the transfer mechanism to deploy a target storage container to the deployed position. One or more signals from the tertiary sensors can be used by the master control system to control the movement of one or more delivery containers on the delivery container conveyance system such that a target delivery container associated with a customer order is moved to a position where the picking mechanism can transfer one or more items from a deployed storage container to the target delivery container on the delivery conveyance system. In yet a further adaption of the embodiment shown in FIG. 21, views (a) and (b), the picking mechanism can be a manual operation. This removes the need and thus, costs of having an automated picking mechanism as discussed above. Like the embodiment shown in FIG. 20, views (a) and (b), one or more delivery containers 10b transported by the delivery conveyance system 506 and the storage container in the deployed position are within easy reach of an operator. To be within easy reach of the storage container in the deployed position, the storage container in the deployed position is interposed between the vertical carousel 500 and the transfer conveyance system 506, i.e., in this case the delivery conveyance system. In operation, the control system can be configured to coordinate the deployment of one or more storage containers to the deployed position when one or more delivery containers arrive at the vertical carousel. Signals from one or more sensors, e.g., primary, secondary and tertiary sensors discussed above, can be used by the control system to coordinate the movement of the plurality of storage containers and thus, carriers, around the vertical endless loop, and the movement of the delivery containers on the transfer conveyance system. To be within easy reach of the storage container in the deployed position, the delivery container is transported to a position adjacent the deployed storage container. An operator can then transfer one or more items picked from the deployed storage container to the delivery container paused on the transfer conveyance system 506 simply by reaching out to the storage container in the deployed position and transferring one or more items picked from the storage container to the delivery container.

In yet a further embodiment of the present invention shown in FIG. 22, views (a) and (b), the transfer conveyance system 606 for transporting one or more delivery containers to the vertical carousel can optionally comprise a mobile device 606 instead of a conveyor. This could be a manually operated mobile device, e.g., a trolley, or an autonomous mobile robot or vehicle as taught in U.S. 2018065809 (Ocado Innovations Ltd.), the details of which are herein incorporated by reference. Whether the mobile device is a manually operated mobile device or an autonomously operated mobile device, the mobile device transports one or more delivery containers 10b to a position adjacent the vertical carousel 600. Movement of the storage container to the deployed position, allows an operator to transfer one or more items from the storage container 10 to one or more delivery containers 10b carried by the mobile device 606 for fulfilling one or more customers. In operation, the mobile device 606 can guide an operator to a target vertical carousel whereupon the operator can manually withdraw a target storage container to deployed position to enable access to one or more items for fulfilling a customer's order in the delivery container. As discussed above with the other embodiments of the present invention described with reference to FIGS. 18 to 21, the transfer mechanism to move the storage container to the deployed position can be a manual operation or an automated operation.

While endeavouring to draw attention to the features of the invention believed to be of particular importance, it should be understood that the applicant claims protection in respect of any patentable feature or combinations of features referred to herein, and/or shown in the drawings, whether or not particular emphasis has been placed on them.

It will be appreciated that the storage and retrieval system can be designed using various combinations of the arrangements described above. Many variations and modifications not explicitly described above are possible without departing from the scope of the invention as defined in the appended claims.

1. A storage and retrieval system comprising:
a) a track system, the track system comprising a plurality of grid members or tracks arranged in a grid pattern comprising a plurality of grid cells or spaces;
b) at least one vertical carousel comprising a drive mechanism for circulating a plurality of storage containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space.

2. A system according to claim 1, wherein the at least one vertical carousel has a width that occupies only two grid cells.

3. A system according to claim 1, wherein the at least one vertical carousel further comprises a series of carriers for accommodating and conveying the plurality of storage containers.

4. The system according to claim 3, wherein a height of the at least one vertical carousel is greater than its width such that the series of carriers are arranged vertically.

5. A system according to claim 3, wherein the carriers comprise shelving.

6. A system according to claim 3, wherein each carrier accommodates a row of storage containers.

7. A system according to claim 1, wherein the lowermost position is arranged to allow retrieval of storage containers at ground level.

8. A system according to claim 1, wherein the at least one vertical carousel comprises a plurality of vertical carousels, said plurality of vertical carousels being disposed laterally to each other to form a row of vertical carousels.

9. A system according to claim 8, wherein each of the plurality of vertical carousels being configured to operate independently or in synchronisation.

10. A system according to claim 1, wherein the system further comprises a load handling device, wherein the load handling device is moveable and operable on the track system, the load handling device comprising a container lifting mechanism for retrieving and/or lowering a storage container through a grid cell or grid space, the container lifting mechanism comprising a grabber device configured to releasably grip a container, and a drive mechanism configured to raise and lower the grabber device.

11. The system according to claim 1, further comprising one or more access positions between the uppermost position and the lowermost position of the endless vertical loop for accessing the content of one or more storage containers from the side of the at least one vertical carousel.

12. The system according to claim 11, further comprising at least one transfer system disposed laterally to the at least one vertical carousel, said transfer system comprising a transfer mechanism configured to transfer a storage container between a stowed position at the access position of the vertical carousel and a deployed position outwardly relative to the at least one vertical carousel such that the contents of the storage container can be accessed therein.

13. The system according to claim 12, wherein said at least one transfer system further comprises a transfer conveyance system for transporting a container across at least one vertical carousel, said transfer conveyance system is disposed laterally to the at least one vertical carousel.

14. The system according to claim 12, wherein the transfer mechanism comprises at least one grabber device moveable in a direction substantially perpendicular to an axis of rotation of the vertical endless loop to engage with a storage container at the access position.

15. The system according to claim 12, wherein the transfer mechanism comprises at least one shuttle having a support deck for supporting a storage container, said shuttle being moveable along one or more tracks across the at least one carousel.

16. The system according to claim 12, wherein the at least one transfer system comprises a first transfer system and a second transfer system, said first transfer system being configured to transfer at least one storage container from the at least one vertical carousel to the deployed position and said second transfer system being configured to transfer at least one storage container to the stowed position in the at least one vertical carousel.

17. The system according to claim 12, further comprises a picking mechanism comprising a picking arm comprising an end effector configured to pick one or more items from the storage container in the deployed position and transfer the one or more picked items to one or more delivery containers.

18. The system of claim 17, wherein the picking mechanism is mounted to a gantry, said gantry being configured to move the picking mechanism in a lateral direction between the retrieval container mechanism and the transfer conveyance system.

19. A method of moving a storage container around a storage and retrieval system, the storage and retrieval system comprising:
a) a track system comprising a plurality of grid members to form a grid pattern comprising a plurality of grid cells or spaces;
b) at least one vertical carousel comprising a drive mechanism for circulating a plurality of containers around a vertical endless loop from a lowermost position to an uppermost position adjacent to the track system;
c) a control system operatively coupled to the drive mechanism, the control system being configured to index the plurality of containers around the endless vertical loop in sequential steps, each of the sequential steps corresponding to at least one of the plurality of storage containers being aligned with a grid space or grid cell of the track system such that a storage container can be retrieved and/or lowered through the grid cell or grid space;
the method comprising the steps of:
i) circulating the vertical carousel such that a desired storage container on the vertical carousel is at one or more access positions between the uppermost position and lowermost position of the endless vertical loop for accessing the content of one or more storage containers from the side of the at least one vertical carousel;
ii) removing the desired storage container from the vertical carousel by moving the desired storage container outwardly relative to the vertical carousel to define a deployed position.

20. The method of claim 19, wherein the at least one vertical carousel comprises a plurality of vertical carousels, said plurality of vertical carousels being disposed laterally to each other to form a row of vertical carousels, said control system operatively coupled to the drive mechanism of each of the plurality of vertical carousels to drive each of the plurality of vertical carousels independently or in synchronisation.
